(19) United States
(12) Patent Application Publication
(10) Pub. No.: US 2013/0014112 A1
(43) Pub. Date: Jan. 10, 2013

(54) INFORMATION PROCESSING APPARATUS AND DATA MANAGEMENT SYSTEM

(75) Inventor: Takayori NISHIDA, Tokyo (JP)

(73) Assignee: Ricoh Company, Ltd., Tokyo (JP)

(21) Appl. No.: 13/532,995

(22) Filed: Jun. 26, 2012

(30) Foreign Application Priority Data
Jul. 5, 2011 (JP) 2011-149468

(51) Int. Cl. G06F 9/46

(52) U.S. Cl. 718/100

(57) ABSTRACT

An information processing apparatus is connected to both plural data accumulation devices configured to accumulate job data in a predetermined memory area and plural electronic devices configured to execute the accumulated job data through a predetermined data transmission line. The data accumulation devices execute a deletion process based on a deletion control value included in management information and manage the accumulated job data. The apparatus includes a control unit configured to control a communication process of the job data performed between the electronic devices and the data accumulation devices. The control unit is configured to transmit a control value for extending an accumulation period of the accumulated job data to at least one of the data accumulation devices, and to update the deletion control value of the management information retained in the predetermined memory area in the at least one of the data accumulation devices.

### BACKGROUND OF THE INVENTION

1. Field of the Invention

The present invention relates to an art of managing job data in a system where an electronic device executes a job accumulated in a server, and in particular to an information processing apparatus and a data management system.

2. Description of the Related Art

For example, Japanese Patent Application Laid-Open Publication No. 2008-107921 (which is called “Patent Document 1” hereinafter) discloses a pull-print system including a print control server. By this system, a user can leave print jobs to accumulate in the print control server without specifying a printer to print, and perform printing by executing the accumulated print jobs from a printer installed at a local spot.

Moreover, in recent years, sometimes such a system may be introduced into an extensive user environment. Accordingly, some pull-print systems may be able to execute a print job that a user has accumulated even in a network area where the printer to print and a print control server are different.

However, unfortunately, in conventional systems, because an accumulated print job is automatically deleted depending on an accumulation period that an administrator has preliminarily set or an execution state in a print control server, a user cannot execute the print job if the print job has already been deleted when the user desires to run the print job again.

This automatic deletion function is to prevent a storage capacity of an accumulation unit from being depleted during system operation. For example, the function is carried out by performing the deletion at regular intervals or by performing the deletion depending on the job execution status and the like. However, such a simple automatic deletion is not convenient for a user as mentioned above.

In response to this, for example, it is considered to take measures to adopt a structure that enables a user to set whether to execute the automatic deletion. In this case, for every print job, the user is required to set whether to delete the print job, and this work interrupts the user. Moreover, for example, it is considered to take measures to adopt a structure that sends the print job again to the print control server so that the print job is accumulated again. In this case, the user is still required to send the print job each time it occurs, and the work also interrupts the user.

Given this situation, in the pull print system, it is desired to implement a data management system that can prevent a memory capacity of a storage unit from being depleted and does not lack convenience for a user.

### SUMMARY OF THE INVENTION

Accordingly, embodiments of the present invention may provide a novel and useful information processing apparatus, data management system and information processing method solving or reducing one or more of the above-described problems.

More specifically, the embodiments of the present invention may provide an information processing apparatus, a data management system and an information processing method that can perform data management for an accumulated job without lacking convenience for a user.

According to one embodiment of the present invention, an information processing apparatus connected to both plural data accumulation devices configured to accumulate job data in a predetermined memory area and plural electronic devices configured to execute the accumulated job data through a predetermined data transmission line, the data accumulation devices executing a deletion process based on a deletion control value included in management information to manage the accumulated job data and managing the accumulated job data within a capacity of the predetermined memory area is provided, the apparatus including:

a control unit configured to control a communication process of the job data performed between the electronic devices and the data accumulation devices;

wherein the control unit is configured to transmit a control value for extending an accumulation period of the accumulated job data to at least one of the data accumulation devices in the communication process from at least one of the electronic devices to the at least one of the data accumulation devices, and to update the deletion control value of the management information retained in the predetermined memory area in the at least one of the data accumulation devices.

According to another embodiment of the present invention, an information processing apparatus connected to both plural data accumulation devices configured to accumulate job data in a predetermined memory area and plural electronic devices configured to execute the accumulated job data through a predetermined data transmission line, the data accumulation devices performing a deletion process based on a deletion control value included in management information to manage the accumulated job data, and managing the accumulated job data within a capacity of the predetermined memory area is provided, the apparatus including:

a control unit configured to control a communication process of the job data performed between the electronic devices and the data accumulation devices;

wherein the control unit is configured to acquire the accumulated job data from at least one of the data accumulation devices in an installation area different from at least one of the electronic devices in the communication process from the at least one of the electronic devices to the at least one of the data accumulation devices, and to transmit the acquired accumulated job data to any of the plural data accumulation devices.

According to another embodiment of the present invention, a data management system is provided, the system including:

plural data accumulation devices configured to accumulate data in a predetermined memory area, to execute a deletion process based on a deletion control value included in management information for managing the accumulated data, and to manage the accumulated job data within a capacity of the predetermined memory area;

plural electronic devices configured to execute the accumulated job data and connected to the plural data accumulation devices through a predetermined data transmission line; and

an information processing apparatus connected to both the plural data accumulation devices and the plural electronic devices through predetermined data transmission lines,

wherein the information processing apparatus includes a control unit configured to control a communication process of the data performed between the electronic devices and the data accumulation devices;

wherein the control unit is configured to transmit a control value for extending an accumulation period of the accumulated job data to at least one of the data accumulation devices in the communication process from at least one of the electronic devices to the at least one of the data accumulation devices, and to update the deletion control value of the management information retained in the predetermined memory area in the at least one of the data accumulation devices.

According to another embodiment of the present invention, an information processing method used for plural data accumulation devices configured to accumulate job data in a predetermined memory area and plural electronic devices configured to execute the accumulated job data through a predetermined data transmission line, the data accumulation devices executing a deletion process based on a deletion control value included in management information to manage the accumulated data and managing the accumulated job data within a capacity of the predetermined memory area is provided, the method including the steps of:

transmitting a control value for extending an accumulation period of the accumulated data to at least one of the data accumulation devices in the communication process from at least one of the electronic devices to the at least one of the data accumulation devices; and

updating the deletion control value of the management information retained in the predetermined memory area in the at least one of the data accumulation devices.

Other objects, features and advantages of the present invention will become more apparent from the following detailed description when read in conjunction with the accompanying drawings.

### BRIEF DESCRIPTION OF THE DRAWINGS

FIG. 1 is a diagram showing a configuration example of a print control system of a first embodiment of the present invention;

FIG. 2 is a diagram showing a hardware configuration example of a Web server of the first embodiment of the present invention;

FIG. 3 is a diagram showing a hardware configuration example of an image processing apparatus of the first embodiment of the present invention;

FIG. 4 is a diagram showing a functional configuration example of print control and data management of the first embodiment of the present invention;

FIG. 5 is a diagram showing a data example of management information of the first embodiment of the present invention;

FIGS. 6A and 6B are diagrams showing a data example of control information of the first embodiment of the present invention;

FIGS. 7A and 7B are diagrams showing a data example of a job list of the first embodiment of the present invention;

FIG. 8 is a diagram showing an operation screen example of job execution of the first embodiment of the present invention;

FIG. 9 is a sequence diagram showing a processing procedure example of print control of the first embodiment of the present invention;

FIG. 10 is a sequence diagram showing a processing procedure example of an extended job list display of the first embodiment of the present invention;

FIG. 11 is a sequence diagram showing a processing procedure example of data management of the first embodiment of the present invention;

FIG. 12 is a sequence diagram showing a data transition example of management information of the first embodiment of the present invention;

FIG. 13 is a flowchart showing a processing procedure example of job deletion of the first embodiment of the present invention;

FIG. 14 is a diagram showing a functional configuration example of print control and data management of a second embodiment of the present invention;

FIG. 15 is a sequence diagram showing a processing procedure example of print control of the second embodiment of the present invention;

FIG. 16 is a sequence diagram showing a processing procedure example of an extended job list display of the second embodiment of the present invention;

FIG. 17 is a first sequence diagram showing a data transition example of management information of the second embodiment of the present invention;

FIG. 18 is a sequence diagram showing a processing procedure example of data management of the second embodiment of the present invention;

FIG. 19 is a second sequence diagram showing a data transition example of management information of the second embodiment of the present invention;

FIG. 20 is a flowchart showing a processing procedure example of job deletion of the second embodiment of the present invention;

FIG. 21 is a diagram showing a functional configuration example of print control and data management of a third embodiment of the present invention;

FIG. 22 is a diagram showing a data example of management information of the third embodiment of the present invention;

FIG. 23 is a sequence diagram showing a processing procedure example of an extended job list display of the third embodiment of the present invention;

FIG. 24 is a sequence diagram showing a processing procedure example of data management of the third embodiment of the present invention; and

FIG. 25 is a flowchart showing a processing procedure example of job deletion of the third embodiment of the present invention.

### DETAILED DESCRIPTION OF THE PREFERRED EMBODIMENTS

A description is given, with reference to the accompanying drawings, of respective embodiments of the present invention.

### First Embodiment

<System Configuration>

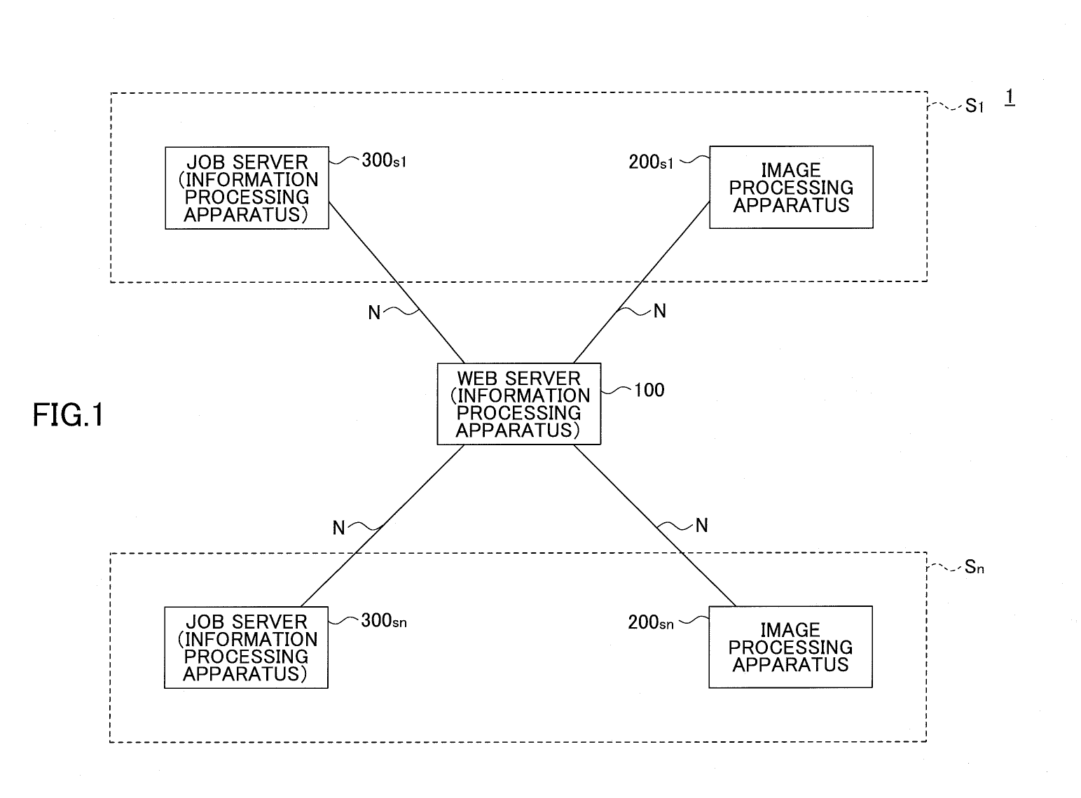

FIG. 1 is a diagram showing a configuration example of a print control system of the present embodiment. FIG. 1 shows a system configuration example in which plural job servers 300ₛ₁-300ₛₙ (which are hereinafter called “a job server 300s or job servers 300s” when named generically), plural image processing apparatuses 200ₛ₁-200ₛₙ (which are hereinafter called “an image processing apparatus 200s or image processing apparatuses 200s” when named generically), and a Web server 100 are connected to each other by way of data transmission lines N such as a wide area network (e.g., “WAN: Wide area Network”).

Moreover, in the print control system 1, predetermined areas S₁-Sₙ (which are hereinafter called “an installation area S or installation areas S” when named generically) where job servers 300s or image processing apparatuses 200s are installed are shown. These installation area S, for example, corresponds to an office (i.e., business) or an area (i.e., a trade area). Accordingly, the print control system 1 assumes a wide system.

Furthermore, in the print control system 1, the Web server 100 is located between the job servers 300s and the image processing apparatuses 200s on the data transmission lines N. Hence, in the print control system 1 of the present embodiment, the job servers 300s and the image processing apparatuses 200s perform data communication through the Web server 100.

Here, a description is given about the above-mentioned respective devices. The job servers 300s are server devices that have an accumulated job management function. The job servers 300s are, for example, job accumulation devices implemented by PCs (Personal Computers) and the like, receive job data for which various execution settings have been configured from an information terminal (which is not shown in the drawing), and store and manage the received job data in a predetermined memory area.

The image processing apparatuses 200s are electronic devices that have an image processing function. The image processing apparatuses 200s are, for example, LPs (Laser Printers) or MPFs (Multifunction Peripherals) and the like. If the image processing apparatuses 200s are the MPFs, the mounted image processing function includes, for example, a copy function, a scanning function, a print function and the like.

The Web server 100 is a server device that has a relay function in data communication between the job servers 300s and the image processing apparatuses 200s. The Web server 100 is, for example, a relay apparatus implemented by a PC and the like, and provides the relay function by a Web service (HTTP: Hypertext Transfer Protocol Communication) for the job servers 300s and the image processing apparatuses 200s. When the Web server 100 receives a job list acquisition request from an image processing apparatus 200s through the Web service, the Web server 100 obtains a job list (i.e., a print job catalog) from a job server 300s in accordance with the acquisition request, and transmits the acquired job list to the image processing apparatus 200s. In addition, when receiving an execution job acquisition request from an image processing apparatus 200s via the Web service, the Web server 100 obtains corresponding job data from the job server 300s according to the acquisition request, and sends the acquired job data to the image processing apparatus 200s. In this manner, the Web server 100 controls the data acquisition request and the response process related to the job between the job server 300s and the image processing apparatus 200s.

Accordingly, the print control system 1 provides services as follows for a user. For example, the user transmits job data in which various operations have been set from an information terminal, and accumulates the job data in a job server 300ₛ₁ in the same installation area S₁ as the area ₛ₁ where the user is on the register. The user moves to an area ₛₙ different from the area ₛ₁ where the user is on the register, the user tries to implement the job accumulated in the job server 300ₛ₁ from an image processing apparatus 200ₛₙ in the installation area 200ₛₙ. At this time, the user logs into the image processing apparatus 200ₛₙ. By doing this, the image processing apparatus 200ₛₙ displays a job list of the user obtained from the job server 300ₛ₁ on its screen through the Web server 100. The user selects a job from the job list, and instructs the image processing apparatus 200ₛₙ to run the job. This causes the image processing apparatus 200ₛₙ to print the corresponding job data obtained from the job server 300ₛ₁ through the Web server 100.

As stated above, the print control system 1 of the present embodiment can provide a print control service of a job accumulated in plural job servers 300s indifferent installation areas S according to the above-mentioned system configuration.

<Hardware Configuration>

<<Web Server>>

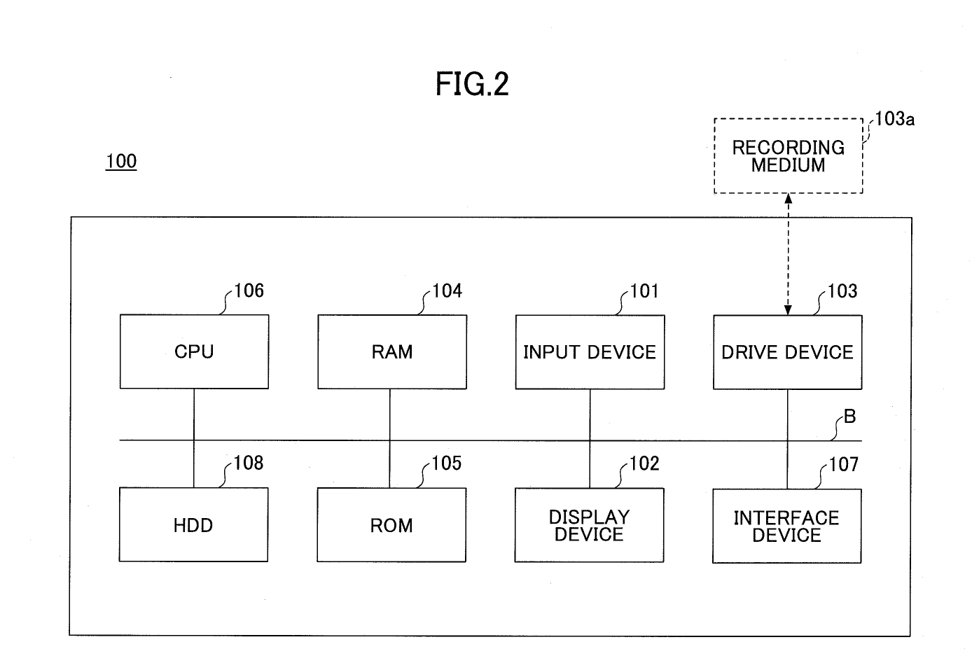

FIG. 2 is a diagram showing a hardware configuration example of the Web server 100 of the present embodiment. Here, because the job server 300s is an information processing apparatus same as the Web server 100, the description is omitted.

As shown in FIG. 2, the Web server 100 includes an input device 101, a display device 102, a drive device 103, a RAM (Random Access Memory) 104, a ROM (Read-Only Memory) 105, a CPU (Central Processing Unit) 106, an interface device 107, a HDD (Hard Disk Drive) 108 and the like, and each of them is connected to each other through a bus B.

The input device 101 includes a keyboard or a mouse and the like, and is used to input respective operation signals to the Web server 100. The display device 102 includes a display and the like, and displays a processing result by the Web server 100.

The interface device 107 is an interface that connects the Web server 100 to a data transmission line N. With this, the Web server 100 can perform data communication with the job servers 300s or the image processing apparatuses 200s through the interface device 107.

The HDD 108 is a non-volatile memory device that stores a program or data. The program or data to be stored includes an information processing system that controls the entire apparatus (e.g., an OS (Operating System) to be basic software such as “Windows” (Trademark or Registered Trademark) or “UNIX” (Trademark or Registered Trademark)), an application that provides various functions on the system and the like. Moreover, the HDD 108 manages the stored program or data by a predetermined file system and/or a DB (Data Base).

The drive device 103 is an interface with a detachable recording medium 103a. With this, the Web server 100 can perform reading and/or writing to the recording medium 103a via the drive device 103. The recording medium 103a, for example, includes a floppy (Trademark or Registered Trademark) disc, a CD (Compact Disk), a DVD (Digital Versatile Disk), an SD memory card, a USB memory (Universal Serial Bus memory) and the like.

The ROM 105 is a non-volatile semiconductor memory (memory device) that can store internal data even after the power is off. The ROM 105 stores a program or data like BIOS (Basic Input/Output System) that is executed at the time of startup, and settings of an information process and a network. The RAM 104 is a volatile semiconductor memory (memory device) that temporary stores a program or data. The CPU 106 is a processing device that implements control of the entire device and a mounted function by reading the program or data on the RAM (i.e., memory) 105 and by running the process.

As discussed above, the Web server 100 of the present embodiment can provide an information processing service in accordance with the above-stated hardware configuration. Here, the Web server 100 may be configured without the input device 101 and the display device 102. The job server 300 is similar with respect to this point.

<<Image Processing Apparatus>>

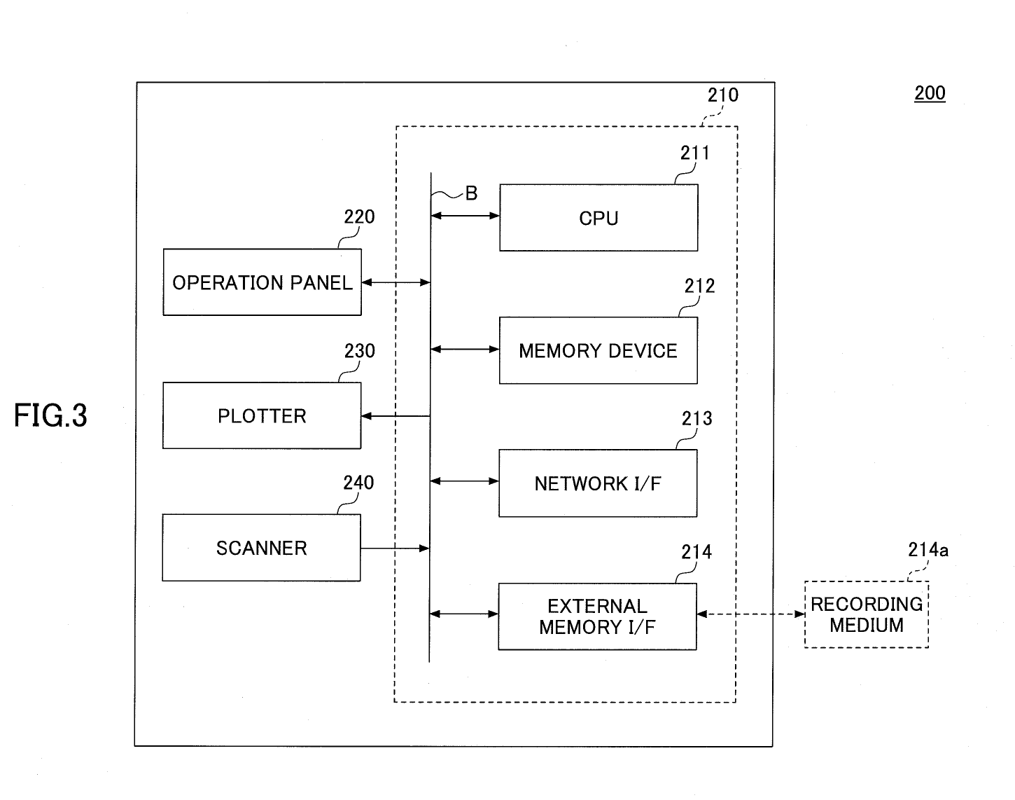

FIG. 3 is a diagram showing a hardware configuration example of an image processing apparatus 200 of the present embodiment. As shown in FIG. 3, the image processing apparatus 200 includes a controller 210, an operation panel 220, a plotter 230, a scanner 240 and the like, and each of them is connected to each other through the bus B.

The operation panel 220 includes a display part and an input part, provides a variety of information such as device information for a user, and accepts various user operations such as an operation setting or an operation instruction and the like. Here, a job list obtained from the job management device 100 is displayed on the display part of the operation panel 220, and the input part and the like such as a predetermined GUI (Graphical User Interface) accept a job execution instruction from a user.

The plotter 230 includes an image formation part, and forms an output image on a paper sheet. A method of forming the output image includes, for example, an electrophotographic process or an ink-jet method. The scanner 240 reads a manuscript optically, and generates a read image.

The controller 210 includes a CPU 211, a memory device 212, a network I/F 213, and an external memory I/F 214 and the like, and each of them is connected to each other through the bus B.

The CPU 211 controls the entire apparatus by running a program. Furthermore, the memory device 212 stores and retains the above-mentioned program or various data (e.g., “image data”). The memory device 212 includes, for example, a RAM to be a volatile memory, a ROM to be a non-volatile memory, a HDD including a high-capacity memory area and the like. The RAM functions as a work area of the CPU 211 (i.e., a memory area where programs or data are read temporarily). The ROM or HDD is used as a storage unit of a program or various data. With this, in the image processing apparatus 200, the CPU 211 reads a program stored in the ROM on the RAM (memory), and runs the program.

The network I/F 213 is an interface to connect the image processing apparatus 200 to the predetermined data transmission line N such as a network. The external memory I/F 214 is an interface to connect a recording medium 214a corresponding to the external memory device to the controller 210. The recording medium 214a includes, for example, an SD memory card or USB memory (Universal Serial Bus memory) and the like. With this, the image processing apparatus 200 reads a program or data stored in the recording medium 214a through the external memory I/F 214.

As stated above, the image processing apparatus 200 of the present embodiment can provide an image processing service by adopting the above-mentioned hardware configuration.

<Data Management Function in Print Control>

A description is given about a data management function of the present embodiment. When the Web server 100 of the present embodiment accepts a job execution notice from the image processing apparatus 200s, the Web server 100 creates an execution result including a control value for extending an accumulation period of an accumulated job corresponding to the execution job, and transmits the created execution result to the job server 300s in which the execution job is accumulated. As a result, in the job server 300s, management information of the corresponding accumulated job (i.e., an item value related to deletion control of a job attribution) is updated based on the control value included in the execution result. By doing this, in the job server 300s, a job deletion is performed based on the updated management information, and timing of deleting the accumulated job is extended. The Web server 100 of the present embodiment has such a data management function.

Conventionally, because the accumulated job is automatically deleted in the print control server, when the user desires to implement the job again, the job has been already deleted from the print control server, and the user cannot implement the job. Thus, the conventional data management function lacks convenience for a user.

Accordingly, the Web server 100 of the present embodiment has a structure that sets deletion control that extends the accumulation period of the accumulated job in the job server 300s.

With this, the print control system 1 of the present embodiment provides an environment where the accumulated job is not deleted for the extended accumulation period (i.e., the timing of deleting the accumulated job is extended). As a result, the print control system 1 of the present embodiment can perform data management for the accumulated job without lacking convenience of a user.

A description is given about a print control function and a configuration and operation of a data management function hereinafter.

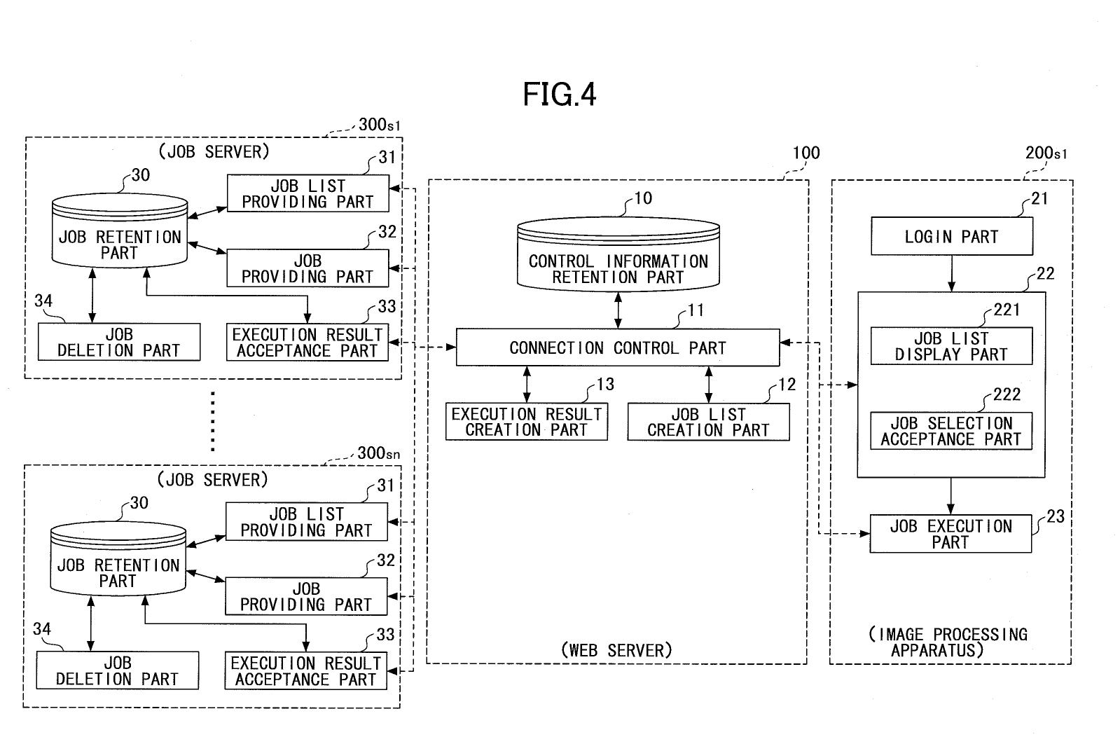

FIG. 4 is a diagram showing a functional configuration example of print control and data management of the present embodiment. As shown in FIG. 4, the print control function of the present embodiment includes a connection control part 11, a job list creation part 12, a login part 21, a job acquisition part 22, a job execution part 23, a job list providing part 31, and a job providing part 32. The connection control part 11 and the job list creation part 12 are functional parts included in the Web server 100. The login part 21, the job acquisition part 22 and the job execution part 23 are functional parts included in the image processing devices 200s. The job list providing part 31 and the job providing part 32 are functional parts included in the job servers 300s.

On the other hand, the data management function of the present embodiment includes an execution result creation part 13, an execution result acceptance part 33, a job deletion part 34 and the like. The job result creation part 13 is a functional part included in the Web server 100. The execution result acceptance part 33 and the job deletion part 34 are functional parts included in the image processing devices 200s.

Thus, the print control function and the data management function of the present embodiment are implemented by allowing the functional parts included in the respective devices to work together.

(1) Print Control Function

<<Job Server>>

The job list providing part 31 is a functional part that transmits and provides a job list to be list information of the accumulated job in response to an acquisition request to the requestor. The job providing part 32 is a functional part that transmits and provides job data of the accumulated job having been instructed to execute to the requestor. These functional parts access a job retention part 30 in which the job data accepted from the user is stored, and obtains the requested corresponding data. Here, the job retention part 30 corresponds to a predetermined memory area of the memory device.

Here, a description is given about a management example of an accumulated job in the job retention part 30.

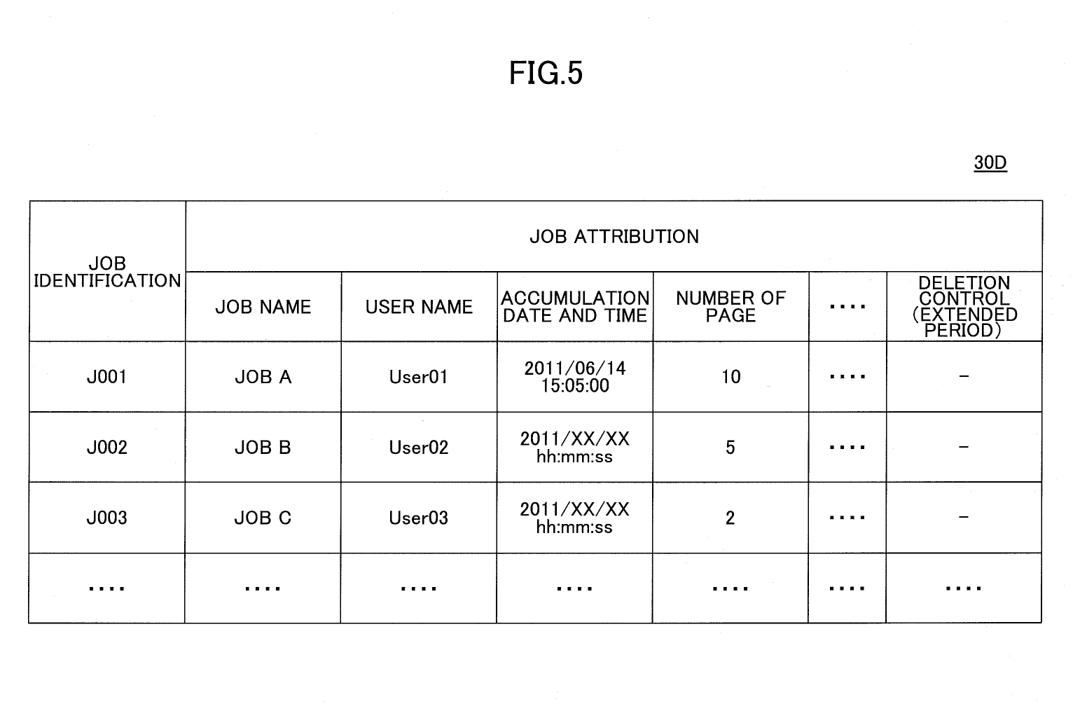

FIG. 5 is a diagram showing a data example of management information 30D of the present embodiment. For example, in the job retention part 30, the stored job data are tied up with the management information 30D in which information items such as [job identification] or [job attribution] are classified in a job unit, and the accumulated job is managed. The [job identification] item is an item that retains information to identify the accumulated job (which is hereinafter called “job identification information”), and the item value includes a job ID and the like. The [job attribution] item is an item that retains information of attribution of the accumulated job (which is hereinafter called “job attribution information”), and the item value includes a job name, a user name, an accumulation date and time, a number of pages, a deletion control and the like.

The job attribution information such as the job name, the user name, the accumulation date and time, the number of pages can be, for example, obtained by analyzing the job data when storing the job data, and by extracting various setting values such as bibliographic information included in the job data.

The deletion control in the job attribution information is an item value that controls a deletion process of the accumulated job (which is hereinafter called a “deletion control value”). In accumulating a job, a default value of NULL is retained, and in executing the job, the default value is updated into a control value that extends an accumulation period of the accumulated job (i.e., a value showing the extension period) by a data management function described below. The control value includes, for example, a date and time.

A description is given about FIG. 4 again. The job list providing part 31 refers to the above-mentioned job retention part 30 based on the information to identify a user (which is hereinafter called “user identification information”) such as the user name received in requesting to obtain the job list, and creates a job list of the user by obtaining corresponding management information 30D (i.e., management information including job attribution information in which the user is identified). By doing this, the requested job list is provided from the job list providing part 31.

Moreover, the job providing part 32 refers to the above-mentioned job retention part 30 based on the job identification information such as a job ID received in requesting to obtain a job to be executed, and obtains the tied-up job data by identifying corresponding management information 30D (i.e., management information including the job identification information in which the job ID is identified). By doing this, the requested job data are provided from the job providing part 32.

In this way, the job servers 300s perform the above-mentioned accumulated job management process.

<<Web Server>>

The connection control part 11 is a functional part that controls a connection between the job servers 300s and the image processing apparatuses 200s on the data communication lines N. The connection control part 11 controls a data acquisition request and a response process related to a job performed between both apparatuses. In other words, the Web server 100 relays data related to the job by allowing the connection control part 11 to control the data communication between the job servers 300s and the image processing apparatuses 200s.

The connection control part 11 accesses the control information retention part 10 that retains as the following control information, and controls the connection between the job servers 300s and the image processing apparatuses 200s in accordance with connection rules set in the control information. Here, the control information retention part 10 corresponds to a predetermined memory area of the memory device provided in the Web server 100.

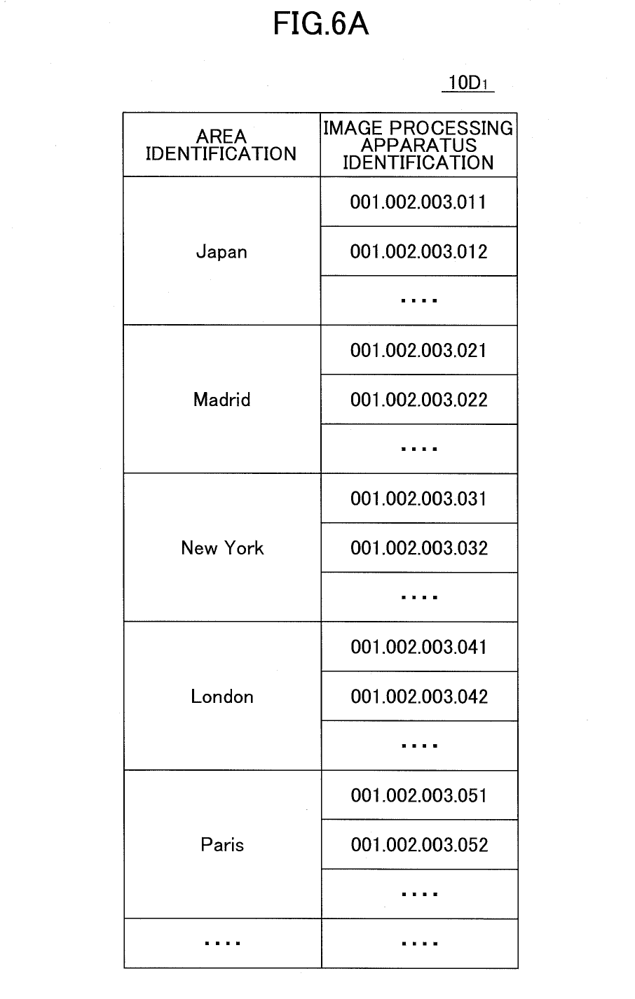

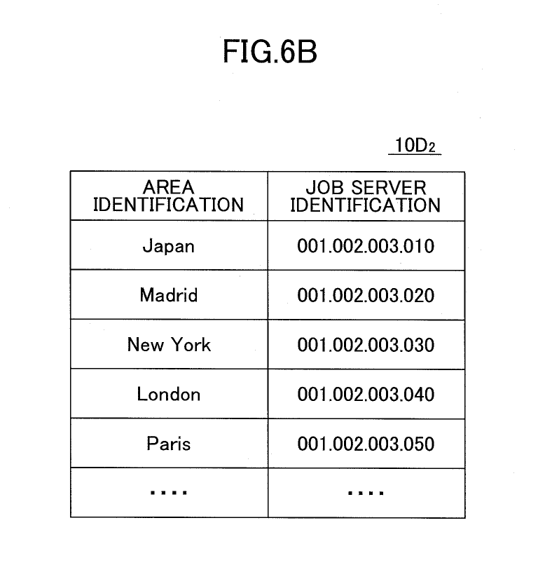

FIGS. 6A and 6B are diagrams showing data examples of two pieces of control information 10D₁ and 10D₂ of the present embodiment. As shown in FIGS. 6A and 6B, in the present embodiment, there are two kinds of information 10D₁ and 10D₂ (which are hereinafter called “control information 10D” when named generically). FIG. 6A shows data examples of the control information 10D₁ (which is hereinafter called “image processing apparatus information 10D₁”) of the image processing apparatus 200s set in each installation area S. FIG. 6B shows data examples of the control information 10D₂ (which is hereinafter called “image processing apparatus information 10D₂”) of the job server 300s set in each installation area S.

An image processing apparatus 200s connected to the system 1 is set by the image processing apparatus information 10D₁, associated with information items such as “area identification,” “image processing apparatus identification” and the like. The “area identification” item is an item to set information for identifying the installation area (which is hereinafter called “area identification information”), and the item value includes an area name and the like. The “image processing apparatus identification” item is an item to set information for identifying the image processing apparatus 200s (which is hereinafter called “apparatus identification information”), and the item values include a network setting value assigned to the image processing apparatus 200s (e.g., “IP address: Internet Protocol address”).

The job server 300s connected to the system 1 is set by job server information 10D₂ associated with the information items such as “area identification”, “job server identification” and the like. The “area identification” item is an item to set the area identification information. The “job server identification” item is an item to set information for identifying the job server 300s (which is hereinafter called “server identification information”), and the item values include a network setting value assigned to the job server 300s and the like.

Here, the above-mentioned item values are, for example, set by an administrator. Conventionally, because such control information 10D is retained in each job server 300s, a management task is performed in each job server 300s in an installation area. However, in the present embodiment, because the Web server 100 manages the control information 10D together, the management task can be simplified, which reduces the load of the administrator.

The description returns to FIG. 4. The job list creation part 12 is a functional part to create a job list for the image processing apparatuses 200s. The job list creation part 12 adds the server identification information of the job server 300s to the job list received from the job server 300s, and creates a job list for the image processing apparatus 200s. Moreover, when the Web server 100 receives respective job lists from the plural job servers 300, the job list creation part 12 integrates the plural received job lists into one job list (i.e., merges the data), and creates a job list for the image processing apparatus 200s. Here, in the following description, the job list into which the plural job lists is integrated is called an “integrated job list” for convenience.

In the present embodiment, when the Web server 100 accepts a job acquisition request from the image processing apparatus 200s, the following connection control and job list creation operation are performed.

When the Web server 100 accepts a job list acquisition request at the time of the user's login from the image processing apparatus 200ₛ₁, the Web server 100 receives user identification information and apparatus identification information from the image processing apparatus 200s.

In response to this, the connection control part 11 refers to the image processing apparatus information 10D₁ that the control information retention part 10 retains based on the received apparatus identification information, obtains area identification information associated with the corresponding apparatus identification information, thereby specifies an installation area S₁ of the image processing apparatus 200ₛ₁ to be a requestor. The connection control part 11 refers to the job server information 10D₂ that the control information retention part 10 retains based on the obtained area identification information, obtains the server identification information associated with the corresponding area identification information, thereby determines the job server 300ₛ₂ to be a connection destination.

After that, the connection control part 11 requests a job list acquisition by transmitting the received user identification information to the determined job server 300ₛ₁. The connection control part 11 receives the job list of the user responded from the job server 300ₛ₁, and transfers the received job list to the job list creation part 12. The job list creation part 12 creates a job list for the image processing apparatus 200ₛ₁ by adding the server identification information of the job server 300ₛ₁ to the received job list, and transfers the created job list to the connection control part 11. The connection control part 11 transmits the received job list to the image processing apparatus 200ₛ₁ to be the requestor. By doing this, the image processing apparatus 200ₛ₁ displays the job of the user accumulated in the job server 300ₛ₁ in the same installation area S₁ as that of the image processing apparatus 200ₛ₁ as a list.

At this time, if the user finds the job that the user desires to implement in the displayed job list, the user selects the job on the screen and instructs the job execution to the image processing apparatus 200ₛ₁.

When the Web server 100 accepts an execution job acquisition request from the image processing apparatus 200ₛ₁ from which the execution job is selected, the Web server 100 receives the job identification information and the server identification information from the image processing apparatus 200ₛ₁.

Upon receiving the job identification information and the server identification information, the connection control part 11 requests execution job acquisition by transmitting the received job identification information to the job server 300ₛ₁ specified by the server identification information. The connection control part 11 receives corresponding job data responded from the job server 300ₛ₁, and transmits the received job data to the image processing apparatus 200ₛ₁ to be the requestor. As a result, the image processing apparatus 200ₛ₁ prints the received job data, and executes the job that the user desires to implement.

On the other hand, if the user does not find the job that the user desires to implement in the displayed job list, the user instructs the image processing apparatus 200ₛ₁ to change the job list acquisition destination so as to obtain a job list from a job server 300ₛₙ other than the job server 300ₛ₁ from which the job list has been obtained (i.e., a job server in a different installation area).

When the Web server 100 receives the job list acquisition request in changing the job list acquisition destination from the image processing apparatus 200ₛ₁, the Web server 100 receives user identification information and apparatus identification information from the image processing apparatus 200ₛ₁ again.

In response to the user identification information and the apparatus identification information, the connection control part 11 refers to the image processing apparatus information 10D₁ that the above-mentioned control information retention part 10 holds based on the received apparatus identification information, and specifies an area Sₙ different from the installation area S₁ of the image processing apparatus 200ₛ₁ to be the requestor by acquiring the area identification information that is not associated with the corresponding apparatus identification information. The connection control part 11 refers to the job server information 10D₂ that the above-mentioned control information retention part 10 retains based on the acquired area identification information, and acquires the server identification information associated with corresponding area identification information, thereby determines a job server 300ₛₙ to be a changed connection destination.

After that, the connection control part 11 requests job list acquisition by transmitting the received user identification information to the determined job server 300ₛₙ. The connection control part 11 receives a job list of a user responded by the job server 300ₛₙ, and transfers the received job list to the job list creation part 12. The job list creation part 12 creates a job list for the image processing apparatus 200ₛ₁ by adding server identification information of the job server 300ₛₙ to the received job list, and transfers the created job list to the connection control part 11. Here, the job list creation part 12 creates an integrated job list if receiving plural job lists, and transfers the created job list to the connection control part 11. The connection control part 11 transmits the received job list to the image processing apparatus 200ₛ₁ to be the requestor. By doing this, the image processing apparatus 200ₛ₁ displays the job of the user accumulated in the job server 300ₛₙ in an area Sₙ different from the image processing apparatus 200ₛ₁.

In this way, the Web server 100 performs the above-mentioned relay process.

In the print control system 1 of the present embodiment, first, when the Web server 100 receives a job list acquisition request at the time of a user's login from the image processing apparatus 200ₛ₁, the Web server 100 obtains a job list from a job server 300ₛ₁ in the same installation area S₁ as the image processing apparatus 200ₛ₁, and responds to the image processing apparatus 200ₛ₁ to be a requestor. Through this process, the image processing apparatus 200ₛ₁ displays a job list of a user accumulated in the job server 300ₛ₁ in the same installation area S₁ as the installation area S₁ of the apparatus.

Next, in the print control system 1, if there is no job that the user desires to implement in the displayed job list, the Web server 100 obtains a job list from a job server 300ₛₙ in an installation area different from the image processing apparatus 200ₛ₁ upon receiving a job list acquisition request at the time of changing a job list acquisition destination from the image processing apparatus 200ₛ₁, and responds to the image processing apparatus 200ₛ₁ of the requestor. This causes the image processing apparatus 200ₛ₁ to display a job of a user accumulated in the job server 300ₛₙ in an area Sn different from the installation area S₁ of the apparatus as a list. As a result, in the print control system 1, even if a user moves to an area S₁ different from the installation area Sₙ of the job server 300ₛₙ in which the user has accumulated the job, the job accumulated in the job server 300ₛₙ can be selected from an image processing apparatus 200ₛ₁ in the moving area S₁ and be implemented.

<<Image Processing Apparatus>>

The login part 21 is a functional part that performs a login process of a user. The login part 21, for example, receives input operation of a user from a login screen displayed on an operation panel 220 provided on the image processing apparatus 220s, and acquires login information including user identification information. Here, a method of receiving the login information is not limited to the input on the login screen. For example, the login information can be received by reading a recording medium 214a that records the login information of a user by using a recording medium reading device (not shown in the drawing) connected to the image processing apparatus 200s through the external memory I/F 214.

The job acquisition part 22 is a functional part to acquire an accumulated job of the job server 300s. The image processing apparatus 200s, as discussed above, displays a job list of a user on the screen of the operation panel 220, and accepts a job execution instruction from a user upon accepting selection of a job from the job list. This leads the image processing apparatus 200s to acquire corresponding job data from the job server 300s in which the job instructed to execute is accumulated through the Web server 100. Hence, the job acquisition part 22 includes a job list display part 221 and a job selection acceptance part 222 to achieve these operations.

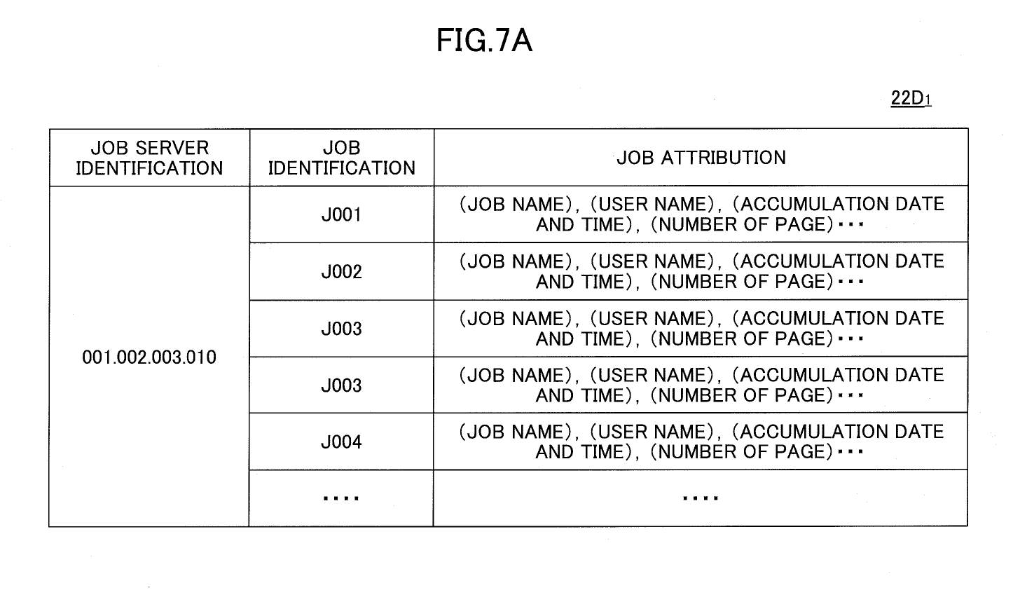

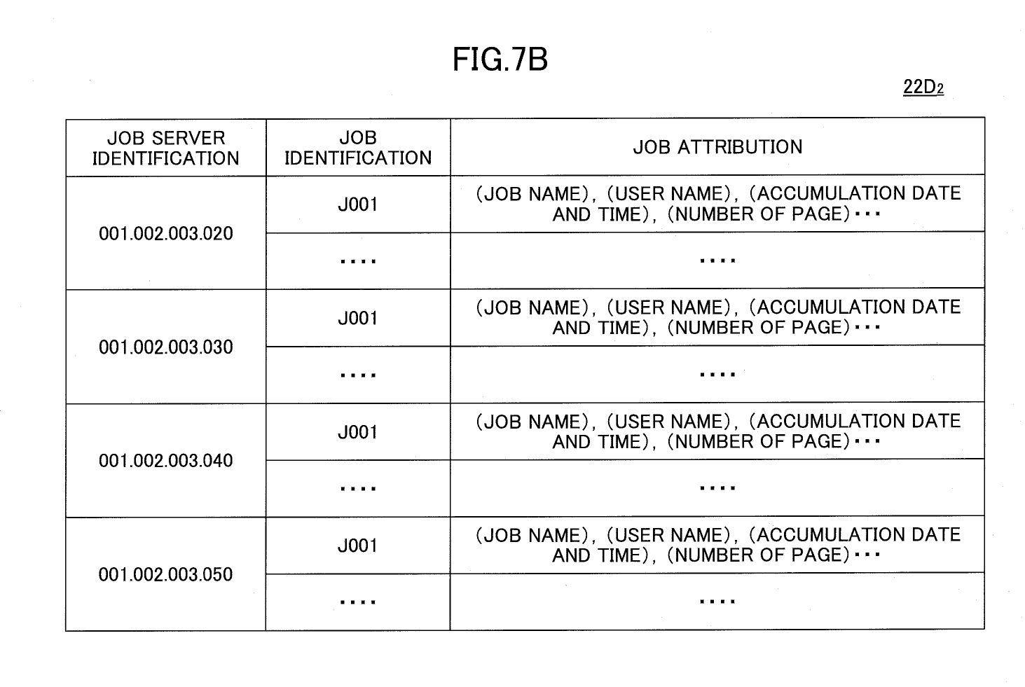

The job list display part 221 is a functional part that displays a job list of a user. When the job list display part 221 accepts an operation event that instructs the job list to display, the job list display part 221 requests a job list acquisition of a login user by transmitting the user identification information included in the login information that the login part 21 has acquired and the apparatus identification information of the image processing apparatus 200s to the Web server 100. As a result, the job list display part 221 receives a job list responded from the Web server 100. The job list display part 221, for example, receives job lists 22D₁ and 22D₂ (which is called a “job list 22D or job lists 22D” when named generically) as shown in FIGS. 7A and 7B.

FIGS. 7A and 7B are diagrams showing data examples of the job lists 22D of the present embodiment. As shown in FIGS. 7A and 7B, in the present embodiment, two kinds of job lists 22D₁ and 22D₂ are obtained in accordance with the kind of a job list acquisition request. FIG. 7A shows a data example of the job list 22D₁ responded to the job list acquisition request when a user logs in. FIG. 7B shows a data example of the job list 22D₂ responded to the job list acquisition request when a job list acquisition destination is changed.

The job list 22D includes item values of information items such as “job server identification”, “job identification”, “job attribution” and the like. The “job server” item is an item of the server identification information, and the item value is a network setting value of the job server 300s that has provided a job list. The “job identification” value is an item of job identification information, and the item value is a job ID of a job that a user has accumulated. The “job attribution” item is an item of job attribution information, and the item values include a job name, a user name, an accumulation data, the number of pages and the like.

When the Web server 100 receives a job list acquisition request at the time of user's login, the Web server 100 determines the job server 300s in the same installation area S as the image processing apparatus 200s to be a job list acquisition destination (i.e., a connection destination). This is because the installation area S of the image processing apparatus 200s is frequently an area where a user is usually on the register, and the user frequently accumulates a job in the job server 300s in the same installation area S as the image processing apparatus 200s, based on which the job list can be obtained from the job server 300s that has a high possibility of the job that the user desires to implement being accumulated. Because of this, the job list display part 221 receives, for example, the job list 22D₁ as shown in FIG. 7A, in which the server identification information of the job server 300s in a specific installation area S is associated with the information about the accumulated job of the user retained in the job server 300s.

On the other hand, if the Web server 100 accepts a job list change request when the job list acquisition destination is changed, the Web server 100 determines the job server 300s in an installation area S different from the image processing apparatus 200s of a requestor to be a job list acquisition destination (i.e., a connection destination). This is because the job list is acquired from the job server 300s to be an accumulation candidate of a job that the user desires to implement other than the job server 300s in the same installation area S as the image processing apparatus 200s to be the requestor. Due to this, the job list display part 221 receives, for example, the job list 22D₂ as shown in FIG. 7B, in which the server identification information of the job server 300s of the plural installation area S and the information about the accumulated job of the user retained in the respective job servers 300s.

In the following descriptions, the job list 22D₁ is called a “basic job list (basic display information) 22D₁”, and the job list 22D₂ is called a “extended job list (extended display information) 22D₂.”

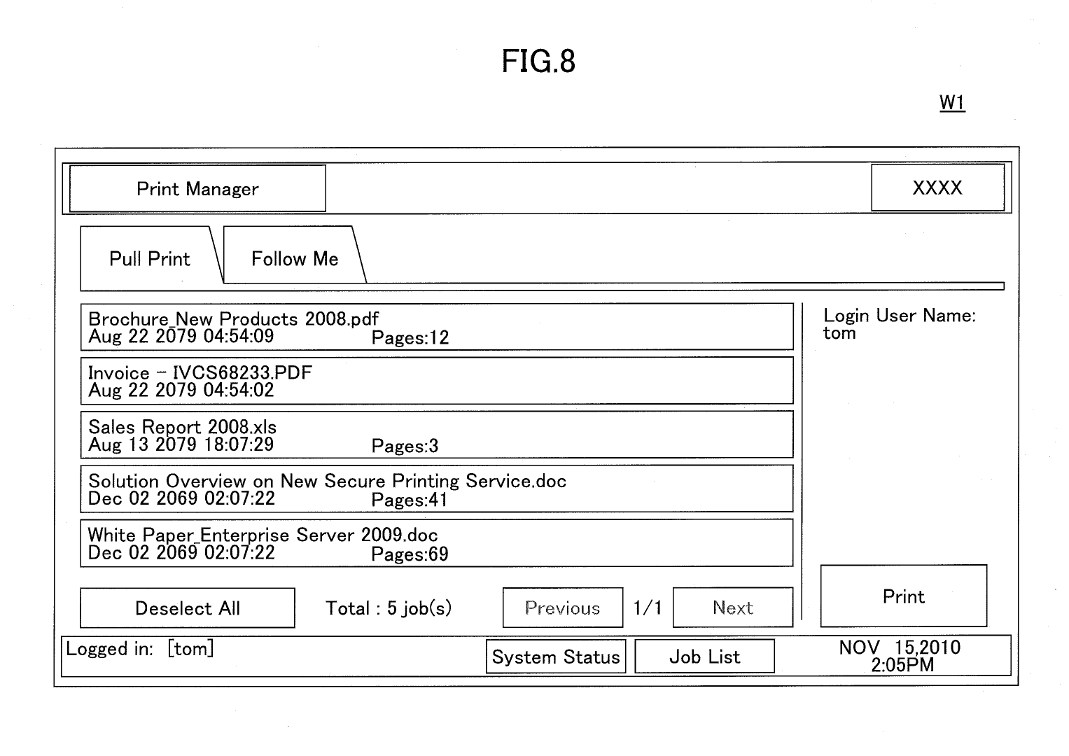

The job list display part 221 displays the received above-mentioned job list 22D on the operation panel 220, for example, as an image shown in FIG. 8.

FIG. 8 is a diagram showing an operation screen example of a job execution of the present embodiment. FIG. 8 shows the operation screen example capable of instructing the job execution by allowing a user to select a job from the job list and to press a “Print” button.

Furthermore, the operation screen W1 shows two tabs. More specifically, the two tabs are a “Pull Print” tab and a “Follow Me” tab. These tabs are displayed in a superimposed manner on the screen. This allows a user switches to display the “Pull Print” screen image and the “Follow Me” screen image by pressing the tabs.

For example, in the operation screen example shown in FIGS. 7A and 7B, the “Pull Print” tab screen image is displayed by being superimposed onto the “Follow Me” screen image.

The “Pull Print” tab screen image is a transition screen image from a login screen image, and is displayed upon receiving an instruction of a job list display from a user. Hence, the basic job list 22D₁ is shown in the “Pull Print” screen image.

On the other hand, the “Follow Me” tab screen image is displayed by being superimposed onto the “Pull Print” tab screen image when the user has pressed the “Follow Me” tab. In the present embodiment, an instruction to change a job list acquisition destination from a user is received based on a press event of the “Follow Me” tab. Accordingly, an extended job list 22D₂ is displayed in the “Follow Me” tab screen image.

The description returns to FIG. 4. The job selection acceptance part 222 is a functional part that receives job selection from a job list. In other words, the job selection acceptance part 222 receives a job execution instruction from a login user. When the job selection acceptance part 222 receives an operation event to select an execution job, the job selection acceptance part 222 acquires server identification information associated with job identification information of the selected job and the selected job, and requests an execution job acquisition of the login user by transmitting the acquired job identification information and the server identification information to the Web server 100. As a result, the job acquisition part 22 receives job data of the execution job responded by the Web server 100.

The job execution part 23 is a functional part that executes a job. The job execution part 23 executes the job data that the job acquisition part 22 has obtained. Here, the present embodiment assumes a print of the job data. Hence, the job execution part 23 sets various operation settings included in the job data in the plotter 230 provided in the image processing apparatus 200s, and performs printing by transferring a raster image converted from the job data.

(2) Data Management Function

<<Web Server>>

The execution result creation part 13 is a functional part that creates transmission data that show an execution result of an accumulated job. The execution result creation part 13 creates transmission data including job identification information of the execution job and a deletion control value (i.e., a control value to extend an accumulation period) of the execution job upon receiving a creation request of an execution result. Here, the connection control part 11 requests the execution result creation part 13 to create the execution result by transferring the job identification information of the execution job upon receiving a job execution notice from the image processing apparatus 200s.

In the present embodiment, when the Web server 100 receives the job execution notice from the image processing apparatus 200s, the following operations of connection control and execution result transmission are performed.

When receiving the job execution notice from an image processing apparatus 200ₛ₁, the Web server 100 receives job identification information of the execution job, server identification information that identifies an accumulation destination of the execution job, and apparatus identification information of the image processing apparatus 200ₛ₁ from the image processing apparatus 200ₛ₁.

Upon receiving these pieces of information, the connection control part 11 refers to the image processing apparatus information 10D₁ retained by the above-mentioned control information retention part 10 based on the received apparatus identification information, and specifies an installation area S₁ of the image processing apparatus 200ₛ₁ to be a notification source by obtaining area identification information associated with the corresponding apparatus identification information. In addition, the connection control part 11 refers to the job server information 10D₂ retained by the above-mentioned control information retention part 10 based on the received server identification information, and specifies an installation area S of the job server 300s corresponding to an accumulation destination of the execution job. The connection control part 11 determines whether the specified two installation areas S are the same or not. In other words, the connection control part 11 determines whether the job server 300s corresponding to the accumulation destination of the execution job, and the image processing apparatus 200ₛ₁ of the notification source are in the same installation area S₁.

After that, the connection control part 11 requests to create an execution result by transferring the determination result (i.e., whether to be in the same installation area) and the job identification information to the execution result creation part 13. This causes the execution result creation part 13 to create transmission data including a deletion control value depending on the determination result.

The deletion control value corresponding to the determination result is preliminarily set in the Web server 100. The setting value of the deletion control includes, for example, a deletion control value corresponding to the determination result in the same installation area S₁ [e.g., 30 minutes], or a deletion control value corresponding to the determination value in a different installation area Sₙ [e.g., three months] and the like.

In a case of the same installation area S₁, the accumulation period is set shorter than that of the different installation area Sₙ because the same installation area S₁ has a higher registration frequency of a user, and is an environment where the job tends to be accumulated again. In contrast, in a case of the different installation area Sₙ, the accumulation period is set longer than that of the same installation area S₁ because the different installation area Sₙ has a lower registration frequency of the user, and is an environment where the job is rarely accumulated again. Thus, the setting value of the deletion control corresponding to the determination result may be set at a proper value in an assumed use situation.

Accordingly, if it is determined that the job server 300s and the image processing apparatus 200ₛ₁ are in the same installation area S₁, the execution result creation part 13 creates transmission data including a setting value [e.g., 30 minutes] of the deletion control corresponding to the determination result of the same installation area S₁ and the job identification information of the execution job. Moreover, if it is determined that the job server 300s and the image processing apparatus 200ₛ₁ are in the different installation area Sₙ, the execution result creation part 13 creates the setting value [e.g., three months] of the deletion control corresponding to the determination result of the different installation area Sₙ and the job identification information of the execution job.

The connection control part 11 transmits the transmission data of the execution result responded from the execution result creation part 13 to the job server 300s that is an accumulation destination of the execution job. In this manner, in the present embodiment, the connection control part 11 functions as a transmission unit of the deletion control value. Furthermore, the connection control part 11 specifies a job server 300s corresponding to a transmission destination of the execution result based on the server identification information that identifies an accumulation destination of the execution job.

After that, the job server 300s receives the execution result of the accumulated job that it retains itself.

Thus, the Web server 100 executes the above-mentioned connection control process and the execution result transmission process, and sets the deletion control in the job server 300s.

<<Job Server>>

The execution result acceptance part 33 is a functional part that receives an execution result of an accumulated job that it retains itself. The execution result acceptance part 33 receives an execution result by receiving the transmission data from the Web server 100.

In addition, upon receiving the execution result from the Web server 100, the execution result acceptance part 33 refers to management information 30D based on the job identification information included in the transmission data, and specifies job attribution information associated with the corresponding job identification information. The execution result acceptance part 33 updates a deletion control value of the specified job attribution information.

The execution result acceptance part 33 calculates an extension period by adding the deletion control value (received value) included in the transmission data to a date and time of the execution result receiving time, and sets the calculated value into a deletion control value of the specified job attribution information (i.e., updated from a NULL into a real value). For example, if the deletion control value included in the transmission data is made [30 minutes], and a data and time when the execution result is received is made [06/14/2011 15:05:00], the execution result acceptance part 33 sets a calculated value of the extension period: [06/14/2011 15:05:00] in the deletion control value of the job attribution value. Moreover, if the deletion control value included in the transmission data is [three (months)], and a date and time when the execution result is received is [06/14/2011 15:05:00], the execution result acceptance part 33 sets a calculated value of the extension value: [09/14/2011 15:05:00] in the deletion control value of the job attribution information.

The job deletion part 34 is a functional part that deletes an accumulated job that it retains itself. The job deletion part 34 refers to the management information 30D that the job retention part 30 retains regularly, and deletes job data that meet a predetermined deletion condition and the management information 30D associated with the job data.

The job deletion part 34 performs a deletion process when the following deletion condition is met. The job deletion part 34 performs the deletion process if the present date and time at the time of determining the deletion condition exceeds the extension period set in the deletion control value of the job attribution information.

Here, the accumulation period of the accumulated job is preliminarily set in the job server 300s for which the deletion process is preliminarily set. In the job server 300s, the job deletion part 34 regularly determines excess of the accumulation date (i.e., deletion condition) as a basic operation, and deletes the job data that meet the condition and the management information 30D associated with the job data.

Hence, in the present embodiment, in order to extend the accumulation period, the determination result of the deletion condition based on the extension period set in the deletion control value has priority over the determination result based on the accumulation period. More specifically, even if the accumulation period of the accumulated job is determined to expire, the job deletion part 34 does not execute the deletion process as long as the present time and date of determining the deletion condition does not go over the extension period set in the deletion control value.

In this way, in the print control system 1 of the present embodiment, an environment where the accumulated job is not deleted during the extended accumulation period is provided.

As discussed above, the print control function and the data management function of the present embodiment can be implemented by the above-mentioned respective functional parts working together. Here, the above-mentioned respective functional parts are implemented by allowing a program (i.e., software to implement the print control function and the data management function) installed in the respective devices that configures the system 1 to be read by an arithmetic device (e.g., CPU) on a memory (e.g., RAM) from a memory device (e.g., “HDD” or “ROM”), and by allowing the respective devices to run the following process.

A description is give about detailed operations (i.e., combined operation of functional part groups) of the print control function and the data management function of the present embodiment by using sequence drawings and flowcharts showing a processing procedure.

<<Main Process of Print Control>>

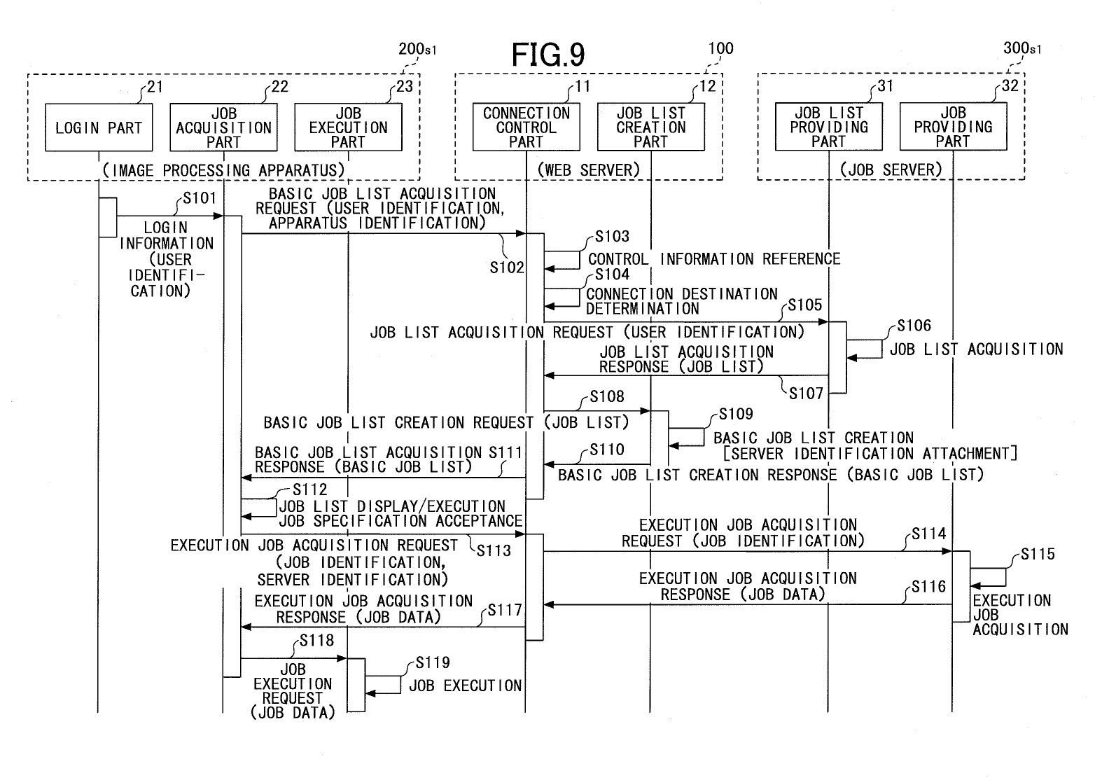

FIG. 9 is a sequence diagram showing a processing procedure example of the print control of the present embodiment. In the image processing apparatus 200ₛ₁ in FIG. 9, a basic job list 22D₁ of a login user is shown, and a processing procedure from receiving an instruction of an execution job to performing printing is shown.

As shown in FIG. 9, the image processing apparatus 200ₛ₁ transfers login information including user identification information of a login user, from a login part 21 to a job acquisition part 22 (step S101).

Next, if the image processing apparatus 200ₛ₁ receives a job list display instruction of the login user on the screen, the image processing apparatus 200ₛ₁ transmits user identification information of the login user and apparatus identification information of the image processing apparatus 200ₛ₁ to the Web server 100 by way of the job acquisition part 22, and requests acquisition of the basic job list 22D₁ (step S102).

Upon receiving the basic job list acquisition request from the image processing apparatus 200ₛ₁, the Web server 100 accesses the control information retention part 10 by way of the connection control part 11, refers to retained control information 10D (step S103), and determines a job server 300s to acquire the basic job list 22D₁ to be a connection destination (step S104).

At this time, for example, if the apparatus identification information of the image processing apparatus 200ₛ₂ is [001. 002. 003. 011], and the connection control part 11 refers to the control information 10D shown in FIG. 6, the connection destination is determined as follows. The connection control part 11 refers to the image processing apparatus information 10D₁ based on the apparatus identification image information received from the image processing apparatus 200ₛ₁, acquires area identification information [Japan] associated with the corresponding apparatus identification information, and specifies the installation area S₂ of the image processing apparatus 200ₛ₂. The connection control part 11 refers to the job server information 10D₂ based on the acquired area identification information, acquires server identification information [001. 002. 003. 010] associated with the corresponding area identification information, and determines the job server 300ₛ₂ to be a connection destination.

Next, the Web server 100 transmits the user identification information received from the image processing apparatus 200ₛ₂ by way of the connection control part 11 to the determined job server 300ₛ₁, and requests acquisition of a job list of the login user (step S105).

Upon receiving the job list acquisition request from the Web server 100, the job server 300ₛ₁ accesses the job retention part 30 by way of the job list providing part 31, and obtains the job list 22D including information about an accumulated job of the login user (step S106). At this time, the job list providing part 31 extracts the corresponding management information of the login user from the management information of the accumulated job based on the user identification information received from the Web server 100, and acquires the job list 22D.

Next, the job server 300ₛ₁ transmits the job list 22D to the Web server 100 by way of the job list providing part 31, and responds to the job list acquisition request (step S107).

When receiving the job list response from the job server 300ₛ₁, the Web server 100 transfers the job list 22D received from the job server 300ₛ₁ to the job list creation part 12 by way of the connection control part 11, and requests to create a basic job list 22D₁(step S108).

Next, the Web server 100 creates the basic job list 22D₁ that is created by adding the server identification information of the job server 300ₛ₁ (connection destination) to the received job list 22D by way of the job list creation part 12 (step S109), transfers the created job list to the connection control part 11, and responds to the basic job list creation request (step S110).

Next, the Web server 100 transmits the received basic job list 22D₁ to the image processing apparatus 200ₛ₁ by way of the connection control part 11, and responds to the basic job list acquisition request (step S111).

Upon receiving the basic job list acquisition request from the Web server 100, the image processing apparatus 200ₛ₁ displays the received basic job list 22D₁ on the screen by way of the job acquisition part 22, and receives a job execution instruction from the login user by allowing the login user to select a job on the screen (step S112).

Upon receiving the job execution instruction of the login user on the screen, the job acquisition part 22 transmits the job identification information of the selected job and the server identification information in which the selected job is accumulated to the Web server 100, and requests acquisition of an execution job (step S113). At this time, the job acquisition part 22 acquires the job identification information of the selected job and the server identification information associated with the selected job from the basic job list 22D₁, and transmits the acquired job identification information and the server identification information to the Web server 100, and requests to acquire a job of the login user.

Upon receiving the job acquisition request from the image processing apparatus 200ₛ₁, the Web server 100 transmits the job identification information received from the image processing apparatus 200ₛ₁ to the job server 300ₛ₁ specified by the server identification information by way of the connection control part 11, and requests to acquire an execution job (step S114).

Upon receiving the execution job acquisition request from the Web server 100, the job server 300ₛ₁ accesses the job retention part 30 by way of the job providing part 32, and acquires the execution job of the login user (step S115). At this time, the job providing part 32 refers to the management information 30D of the accumulated job based on the job identification information received from the Web server 100, and acquires the job data retained to be associated with the corresponding management information 30D from among the accumulated job.

Next, the job server 30ₛ₁ transmits the job data to the Web server 100 by way of the job providing part 32, and responds to the execution job acquisition request (step S116).

Upon receiving the execution job acquisition response from the job server 300ₛ₁, the Web server 100 transmits the job data received from the job server 300ₛ₁ to the image processing apparatus 200ₛ₁ by way of the connection control part 11, and responds to the execution job acquisition request (step S117).

Upon receiving the execution job acquisition response from the Web server 100, the image processing apparatus 200ₛ₁ transfers the job data received from the Web server 100 to the job execution part 23 by way of the job acquisition part 22, and requests execution of a job (step S118).

As a result, the image processing apparatus 200ₛ₁ prints the received job data by way of the job execution part 23, and executes the job that the user desires (step S119).

<<Job List Display Control Process>>

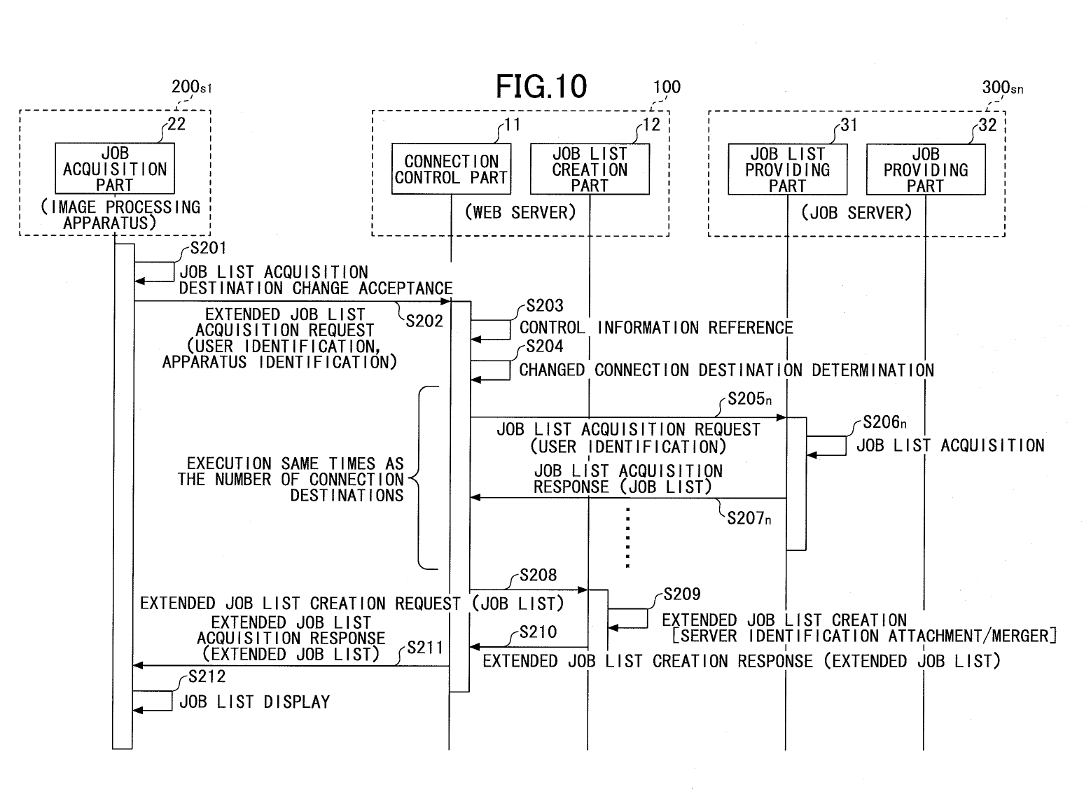

FIG. 10 is a sequence diagram showing a processing procedure example of an extended job list of the present embodiment. FIG. 10 shows a processing procedure example where the image processing apparatus 200ₛ₁ does not have a job that the login user desires to implement in the displayed basic job list 22D₁, receives an instruction to change a job list acquisition destination, and displays an extended job list 22D₂. In other words, FIG. 10 shows a job list display process if the image processing apparatus 200ₛ₁ receives the instruction to change the job list acquisition destination in the process of step S112 shown in FIG. 9.

As shown in FIG. 10, the image processing apparatus 200ₛ₁ receives the job list acquisition destination changing instruction from the login user by allowing the [Follow Me] tab to be pressed on the screen (step S201).

Upon receiving the job list acquisition destination changing instruction of the login user, the image processing apparatus 200ₛ₁ transmits the user identification information of the login user and the apparatus identification information of the image processing apparatus 200ₛ₁ to the Web server 100 by way of the job acquisition part 22, and requests to obtain an extended job list 22D₂ (step S202).

Upon receiving the extended job list acquisition request from the image processing apparatus 200ₛ₁, the Web server 100 accesses the control information retention part 10 by way of the connection control part 11, refers to the retained control information 10D (step S203), and determines the job server 300s that acquires the extended job list 22D₂ as a changed connection destination (step S204).

At this time, for example, if the apparatus identification information of the image processing apparatus 200ₛ₁ is [001. 002. 003. 011], and the connection control part 11 refers to the control information 10D shown in FIG. 6, the connection destination is determined as follows. The connection control part 11 refers to the image processing apparatus information 10D₁ based on the apparatus identification information received from the image processing apparatus 200ₛ₁, acquires area identification information [Madrid]-[Paris] not associated with the corresponding apparatus identification information, and specifies an area Sₙ different from the installation area S₁ of the image processing apparatus 200ₛ₁. The connection control part 11 refers to the job server information 10D₂ based on the acquired area identification information, acquires server identification information [001. 002. 003. 020]-[001. 002. 003. 050] associated with the corresponding area identification information, and determines a job server 300ₛₙ to be a changed connection destination.

Thus, in the Web server 100, if the connection control part 11 obtains plural pieces of server identification information, plural job servers 300 to be the changed connection destinations are determined. In this case, the following process is performed between the Web server 100 and the respective job servers 300ₛₙ.

The Web server 100 transmits the user identification information received from the image processing apparatus 200ₛ₁ to the determined respective job servers 300ₛₙ by way of the connection control part 11, and requests to obtain a job list of the login user (step S205ₙ).

Upon receiving the job list acquisition request from the Web server 100, the respective job servers 300ₛₙ access the job retention part 30 by way of the job list providing part 31, and acquire a job list 22D including information about an accumulated job of the login user (step S206ₙ). At this time, the job list providing part 31 extracts the corresponding management information 30D of the login user from the management information 30D of the accumulated job based on the user identification information received from the Web server 100, and acquires the job list 22D.

Next, the respective job servers 300, transmits the job list 22D to the Web server 100 by way of the job list providing part 31, and responds to the job list acquisition request (step S207ₙ).

In other words, the above-stated process is performed the same number of times as the number of the connection destinations.

Next, upon receiving the job list response from the respective job servers 300ₛₙ, the Web server 100 transfers the plural job lists 22D received from the respective job servers 300ₛₙ to the job list creation part 12 by way of the connection control part 11, and requests to create an extended job list 22D₂ (step S208).

Then, the Web server 100 adds the plural pieces of server identification information of the respective job servers 300ₛₙ (changed connection destination) to the received plural job lists 22D by way of the job list creation part 12, and creates an extended job list 22D₂ by merging the plural job lists to each of which the server identification information is added into one job list 22D (step S209). The job list creation part 12 transfers the created job list 22D₂ to the connection control part 11, and responds to an extended job list creation request (step S210).

Next, the Web server 100 transmits the received extended job list 22D₂ to the image processing apparatus 200ₛ₁ by way of the connection control part 11, and responds to an extended job list acquisition request (step S211).

Upon receiving the extended job list acquisition request, the image processing apparatus 200ₛ₁ displays the received extended job list 22D₂ on the screen by way of the job acquisition part 22 (step S212).

By doing this, in the image processing apparatus 200ₛ₁, an operation screen image W1 for a job execution is switched from a job list display of the user accumulated in the job server 300ₛ₁ of the same installation area S₁ as the installation area S₁ of the image processing apparatus 200ₛ₁ into a job list display of the user accumulated in the job server 300ₛₙ in an installation area Sₙ different from the installation area S₁ of the image processing apparatus 200ₛ₁. As a result, in the print control system 1, even if the user moves to the area S₁ different from the installation area Sₙ of the job server 300ₛₙ in which the user has accumulated the job, the job that the user has accumulated in the job server 300ₛₙ can be selected from the image processing apparatus 200ₛ₁ of the moved area S₁, and can be implemented.

<<Main Process of Data Management>>

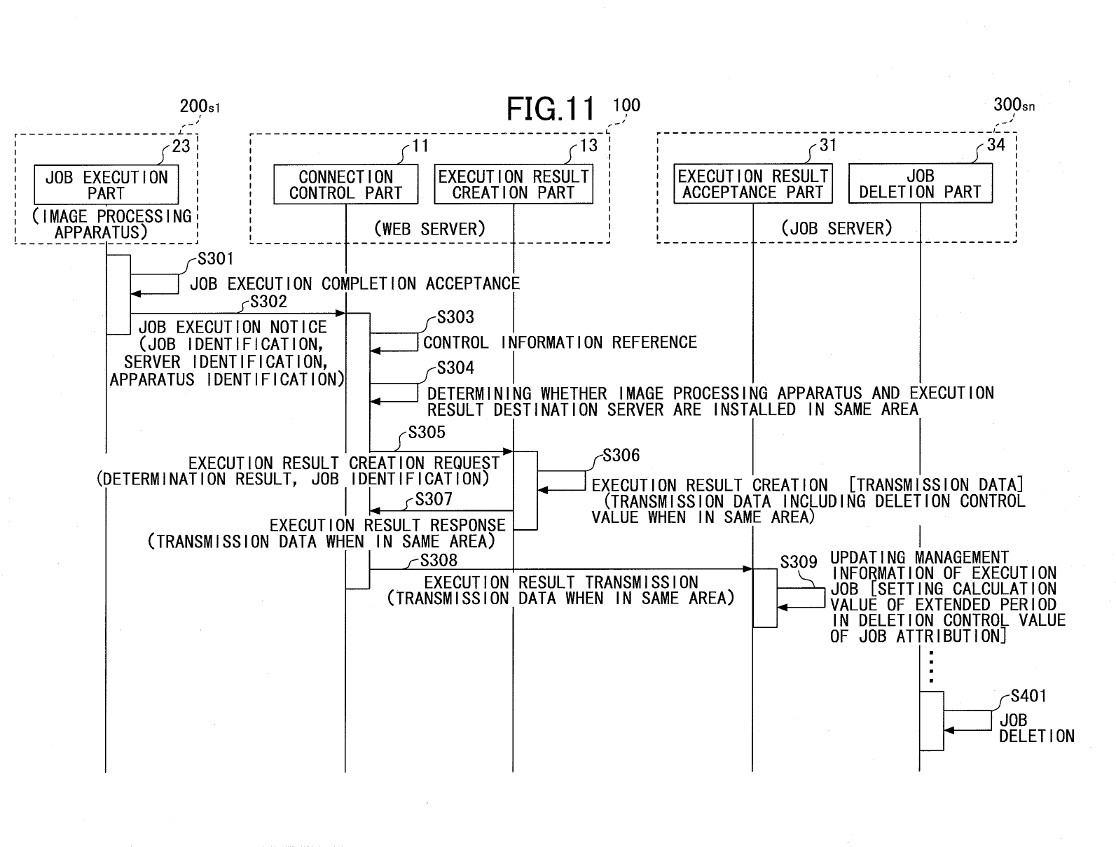

FIG. 11 is a sequence diagram showing a processing procedure example of the data management of the present embodiment. FIG. 11 shows a processing procedure example where the Web server 100 receives a job execution notice from the image processing apparatus 200ₛ₁, transmits an execution result including a deletion control value of a corresponding accumulated job to the job server 300ₛ₁ in which the execution job is accumulated, and the job data are deleted in the job server 300ₛ₁. In other words, FIG. 11 shows a data management process where the image processing apparatus 200ₛ₁ implements the accumulated job in step S119 shown in FIG. 9.

As shown in FIG. 11, upon receiving execution completion of the accumulated job (step S301), the image processing apparatus 200ₛ₁ transmits the job identification information of the execution job, the server identification information to identify an accumulation destination of the execution job, and the apparatus identification information of the image processing apparatus 200ₛ₁ to the Web server 100 by way of the job execution part 23, and notifies a job execution (step S302).

Upon receiving the job execution notification from the image processing apparatus 200ₛ₁, the Web server 100 accesses the control information retention part 10 by way of the connection control part 11, refers to the retained control information 10D (step S303), determines whether the image processing apparatus 200ₛ₁ of the notification source and the job server 300s corresponding to the accumulation destination of the execution job are in the same installation area S₁ (step S304).

At this time, for example, if the apparatus identification information of the image processing apparatus 200ₛ₁ is [001. 002. 003. 011], and the server identification information that identifies the accumulation destination of the execution job is [001. 002. 003. 010], and when the connection control part 11 refers to the control information 10D shown in FIG. 6, the connection control part 11 determines whether the image processing apparatus 200ₛ₁ and the job server 300ₛ₁ are in the same installation area S₁ as follows. The connection control part 11 refers to the image processing apparatus 10D₁ based on the apparatus identification information received from the image processing apparatus 200ₛ₁, acquires the area identification information [Japan] associated with the corresponding apparatus identification information, and specifies the installation area S₁ of the image processing apparatus 200ₛ₁. Moreover, the connection control part 11 refers to the job server information 10D₂ based on the server identification information received from the image processing apparatus 200ₛ₁, acquires the area identification information [Japan] associated with the corresponding server identification information, and specifies the installation area S₁ of the job server 300ₛ₁ corresponding to the accumulation destination of the execution job. The connection control part 11 determines whether the specified two installation areas S are the same or not. In the present embodiment, based on the determination result, the image processing apparatus 200ₛ₁ to be a notification source and the job server 300ₛ₁ corresponding to an execution job accumulation destination are in the same installation area S₁.

The connection control part 11 transfers the determination result and the job identification information of the execution job to the execution result creation part 13, and requests to create an execution result (step S305).

When the execution result creation part 13 receives the execution result creation request from the connection control part 11, the Web server 100 creates a determination result: transmission data including a deletion control value corresponding to “the same installation area S₁” (step S306). At this time, for example, if a preliminarily set setting value of the deletion control corresponding to the determination result of the same area S₁ is [30 (minutes)], the execution result creation part 13 creates transmission data including the deletion control value [30 (minutes)] and the job identification information of the execution job.

The execution result creation part 13 transfers the created transmission data to the connection control part 11, and responds to the request of the execution result creation (step S307).

The Web server 100 transmits the transmission data of the execution result responded from the execution result creation part 13 to the job server 300ₛ₁ (i.e., accumulation destination of the execution job) specified based on the received server identification information by way of the connection control part 11 (step S308).

Upon receiving the transmission data of the execution result from the Web server 100, the job server 300ₛ₁ accesses the job retention part 30 by way of the execution result acceptance part 33, and updates corresponding management information 30D of the execution job (step S309).

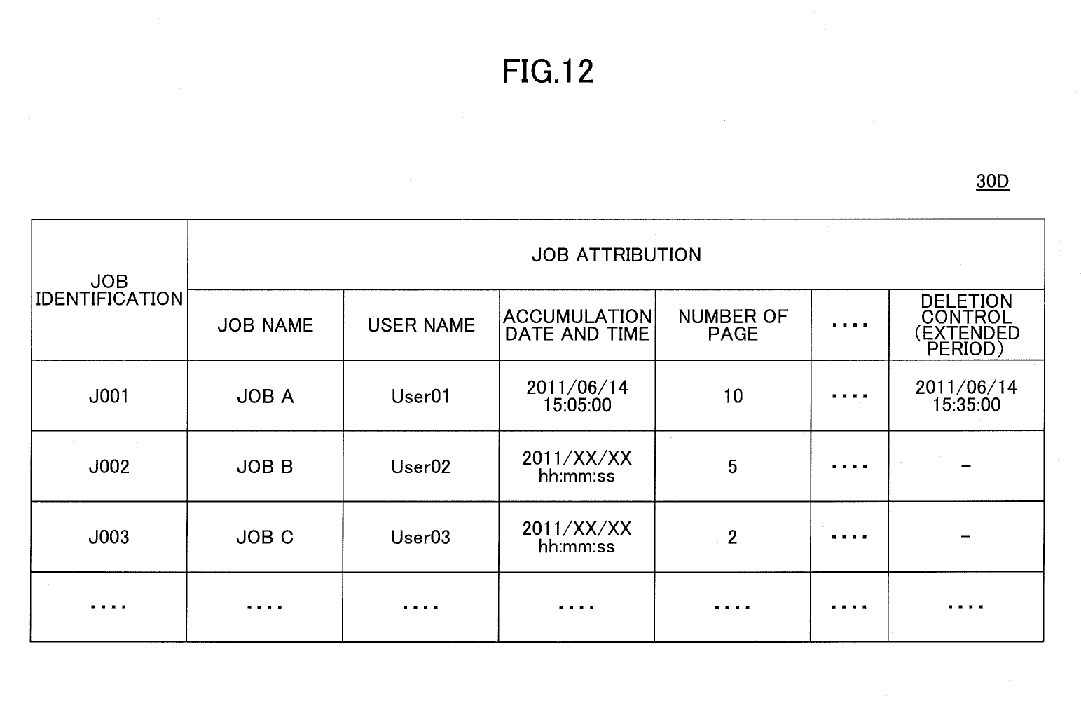

At this time, the execution result acceptance part 33 refers to the management information 30D based on the job identification information included in the transmission data, and specifies job attribution information associated with the corresponding job identification information. For example, if the deletion control value included in the transmission data is [30 (minutes)], and the date and time of receiving the execution result is [06/14/2011 15:05:00], the execution result acceptance part 33 adds the received deletion control value to the date and time of receiving the execution result, sets and updates the calculated value (i.e., calculated value of the extended period) [06/14/2011 15:35:00] into the deletion control value of the specified job attribution information. Because of this, data of the management information 30D of the execution job transitions to data, for example, as shown in FIG. 12.

FIG. 12 is a diagram showing a data transition example of the management information 30D of the present embodiment. FIG. 12 shows the data transition example if the job identification information of the execution job received by the execution result acceptance part is [J001]. As shown in FIG. 12, through the above-mentioned updating process (step S309), the deletion control value of the job attribution information associated with the job identification information [J001] is updated into the extended period: [06/14/2011 15:35:00].

The description returns to FIG. 11. The job server 300ₛ₁ regularly performs the job deletion process asynchronously with the above updating process by way of the job deletion part 34 (step S401). At this time, the job deletion part 34 refers to the management information 30D retained in the job retention part 30, and deletes job data that meets a predetermined condition and the management information 30D tied up the job data based on the deletion control value of the job attribution information.

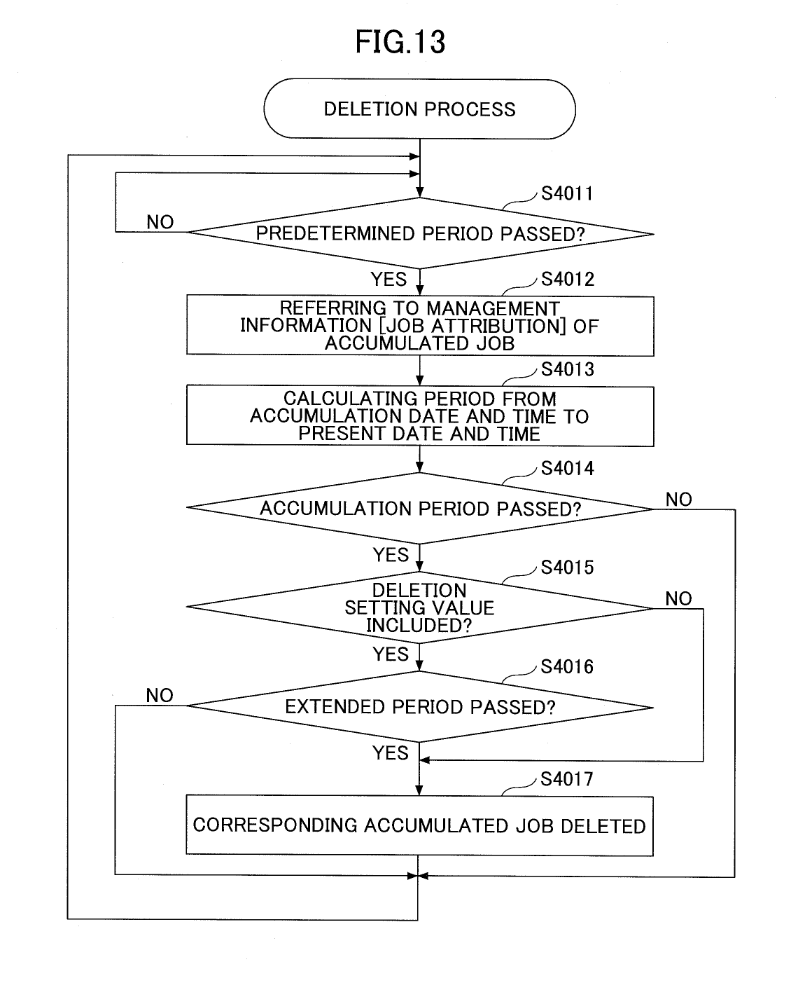

A detailed description is given about the above-stated job deletion process (step S401) by using FIG. 13. FIG. 13 is a flowchart showing a processing procedure example of the job deletion of the present embodiment. As shown in FIG. 13, the job deletion part 34 determines a predetermined time passage preliminarily set as an execution timing of the job deletion (step S4011).

When the predetermined time has passed (step S4011: YES), the job deletion part 34 executes the deletion process based on the following determination result of the deletion condition. However, while the predetermined time has not passed yet (step S4011: NO), the deletion process is not performed.

The job deletion part 34 accesses the job retention part 30, and refers to the job attribution information of the management information 30D (step S4012).

The job deletion part 34 calculates a period from the accumulation date and time of the job attribution information to the present date and time of the deletion determination (step S4013).

The job deletion part 34 determines whether the calculated period goes over an accumulation period of the accumulated job (step S4014). At this time, the job deletion part 34 determines whether the calculated period exceeds the preliminarily set accumulation period.

If a deletion control value is set (step S4015: YES), the job deletion part 34 determines whether an extended period is gone over based on the set deletion control value (step S4016). At this time, the job deletion part 34 determines whether the present date and time of the deletion determination runs over the extended period set by the deletion control value.

Here, if the calculated period goes over the accumulation period, and the deletion control value is not set (steps S4014: YES, S4015: NO), the job deletion part 34 executes the deletion process, on the other hand, if the calculated period does not go over the accumulation period (step S4014: NO) or the present date and time does not run over the extended period (step S4016: NO), the job deletion part 34 does not implement the deletion process.

<Summary>

As discussed above, in accordance with the Web server 100 of the present embodiment, when the connection control part 11 receives the job execution notice form the image processing apparatus 200ₛ, the execution result creation part 13 creates an execution result including a control value to extend an accumulation period of an accumulated job corresponding to an execution job, and transfers the execution result to the connection control part 11. This causes the connection control part 11 to transmit the created execution result to the job server 300s in which the execution job is accumulated. As a result, in the job server 300s, the execution result acceptance part 33 updates management information 30D of corresponding accumulated job (i.e., deletion control value of the job attribution information) based on the control value included in the execution result. This allows the job server 300s to perform job deletion based on the updated management information 30D by way of the job deletion part 34, and timing of deleting the accumulated job is extended.

With this, the print control system 1 of the present embodiment provides an environment in which the accumulated job is not deleted during the extended accumulation period. As a result, in the print control system of the present embodiment, data management of the accumulated job can be performed without lacking convenience for a user.

### Second Embodiment

The first embodiment has suggested a structure where the Web server receives a job execution notice from the image processing apparatus, and transmits an execution result including a deletion control value that extends an accumulation period of an accumulated job to the job server in which an execution job is accumulated, thereby job deletion is not performed during an extended period based on the deletion control value.

In contrast, the second embodiment suggests a structure where the Web server transmits a job list acquisition request including a deletion control value that extends an accumulation period including an accumulated job to the job server in a relay process between the image processing apparatus and the job server when obtaining a job list, thereby job deletion is not performed during an extended period based on the deletion control value.

Hereinafter, a description is given about only matters different from those in the first embodiment, and the same numerals are put to the same matters as in the first embodiment, the description of which is omitted.

<Data Management Function in Print Control>

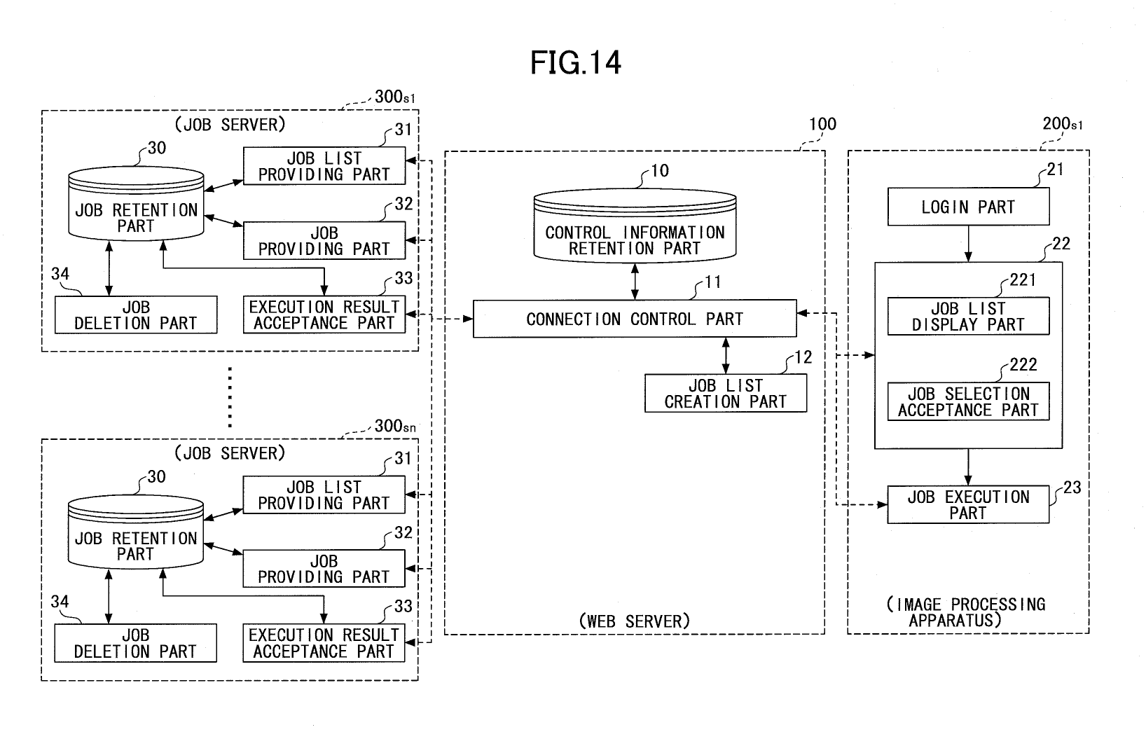

FIG. 14 is a diagram showing a functional configuration example of print control and data management of the present embodiment.

<<Web Server>>

The Web server 100 performs a relay process such as a job list acquisition request and a job list response and the like between the image processing apparatus 200s that has performed a job list acquisition request of a user and the job server 300s determined to be a connection destination to acquire a job list 22.

In the present embodiment, at this time, the connection control part 11 transmits the job list acquisition request including a deletion control value of an accumulated job (i.e., value showing an extended period) included in the job list 22D to the job server 300s.

The connection control part 11 determines whether the job server 300 to be a connection destination and the image processing apparatus 200s to be a requestor are in the same installation area S. The connection control part 11 transmits the job list acquisition request including the deletion control value depending on a determination result (i.e., a setting value of the deletion control corresponding to a determination result of the same installation area/different installation area).

In addition, upon receiving the job execution notice from the image processing apparatus 200s, the Web server 100 receives the job identification information of the execution job and the server identification information to identify an accumulation destination of the execution job from the image processing apparatus 200.

In response to this, the connection control part 11 transmits the received job identification to the job server 300s to be an accumulation destination of the execution job as an execution result of the accumulated job. Here, the connection control part 11 specifies the job server 300s corresponding to a transmission destination of the execution result based on the server identification information that identifies the accumulation destination of the execution job.

By doing this, the job server 300s receives the execution result of the accumulated job retained by itself.

<<Job Server>>

Upon receiving the job list acquisition request form the Web server 100, the job server 300s receives the deletion control value of the accumulated job from the Web server.

In response to this, the job list providing part 31 returns a job list 22D to the requestor, and updates the corresponding management information 30D of the accumulated job included in the job list 22D based on the received deletion control value.

The job list providing part 31 refers to the management information 30D retained by the job retention part 30 based on the received user identification information (i.e., a user name) when having been requested to acquire the job list, and specifies corresponding management information 30D (i.e., management information including the job attribution information whose user name is coincided). The job list providing part 31 sets the deletion control value received when having been requested to acquire the job list in a deletion control value of the job attribution value, and updates the deletion control value. In other words, in a stage of receiving the job list acquisition request, the received value from the Web server 100 is set in the deletion control value of the job attribution information.

In this manner, while the deletion control value is only set in the management information 30D of the accumulated job corresponding to the execution job in the first embodiment, in the present embodiment, the deletion control value is set in the management information 30D of all accumulated jobs of the login user who has requested to acquire the job list 22D.

Upon receiving the execution result of the accumulated job from the Web server 100, the job server 300s receives the job identification information of the execution job from the Web server 100.

In response to this, the execution result acceptance part 33 refers to the management information 30D retained in the job retention part 30 based on the received job identification information, and specifies the job attribution information associated with the corresponding job identification information. The execution result acceptance part 33 updates the specified deletion control value of the job attribution information.

The execution result acceptance part 33 calculates an extended period by adding a deletion control value (received value) set in acquiring the job list to the date and time in receiving the execution result, and sets the calculated value in a deletion control value of the specified job attribution information (updated from the received value to the calculated value). For example, if the deletion control value set in receiving the job list acquisition request is [30 (minutes)], and the date and time in receiving the execution result is [06/14/201115:05:00], the execution result acceptance part 33 resets a calculated value of an extended period: [06/14/2011 15:35:00] in a deletion control value of the job attribution information. Moreover, if the deletion control value set in receiving the job list acquisition request is [three (months)], and the date and time in receiving the execution result is [06/14/2011 15:05:00], the execution result acceptance part 33 resets the calculated value of the extended period: [09/14/2011 15:05:00] in the deletion control value of the job attribution information. In other words, in a stage of receiving the job execution notice, the extended period calculated based on the received value is set in the deletion control value of the job attribution information.

In response to this, the job deletion part 34 regularly refers to the management information 30D retained by the job retention part 30, performs the deletion process if the present date and time goes over an extended period set in the deletion control value of the job attribution information, and does not perform the deletion process unless the present date and time goes over the extended period. Here, the job deletion part 34 does not perform the deletion process if the received value in requesting the job list acquisition is set in the deletion control value of the job attribution information, not the calculated value of the extended period.

Accordingly, in the present embodiment, even if the present date and time runs over the accumulation period, the accumulated job set in which the deletion control value is set in the management information 30D is not deleted, and the deletion process of the accumulated job corresponding to the execution job is performed upon receiving the job execution notice based on the reset deletion control value.

Thus, in the print control system 1 of the present embodiment, an environment is provided in which the accumulated job is not deleted during the extended accumulation period.

<<Main Process of Print Control>>

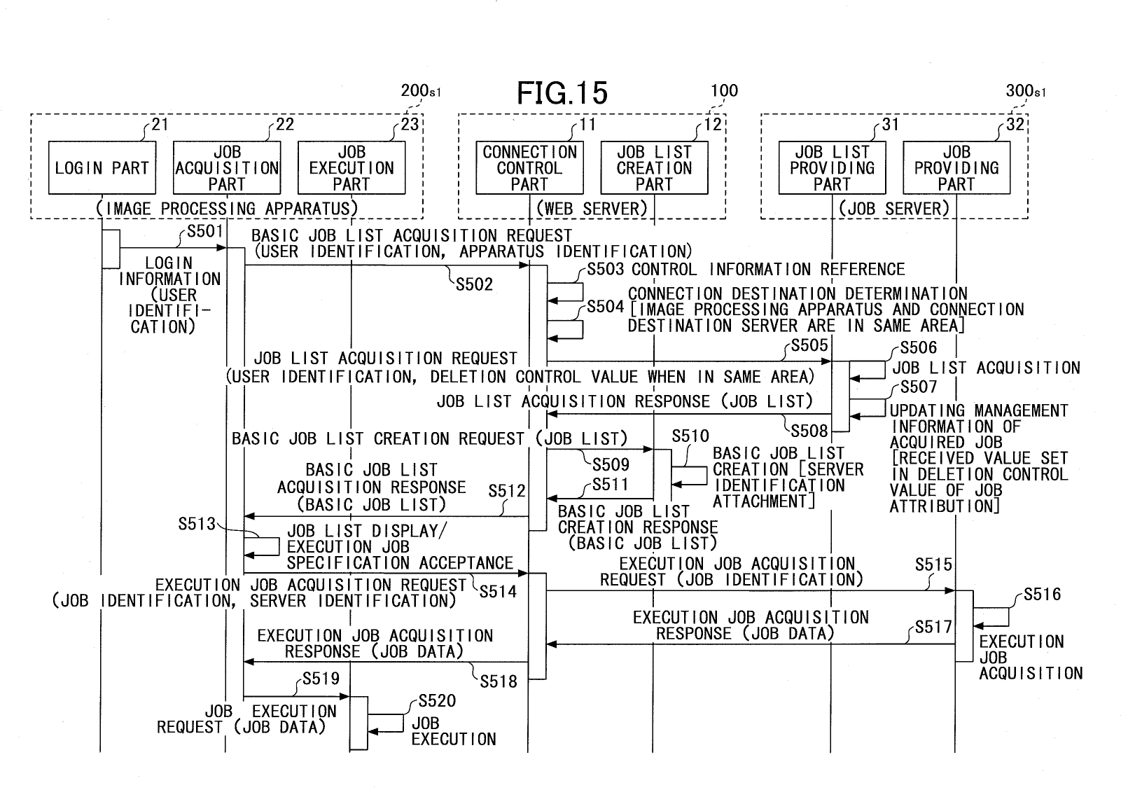

FIG. 15 is a sequence diagram showing a processing procedure example of the present embodiment.

FIG. 15 shows a processing procedure example where a basic job list 22D₁ of a login user is shown in the image processing apparatus 200ₛ₁, and an instruction of an execution job is received, based on which printing is performed. Among this, a process is shown where the Web server 100 transmits a job list acquisition request including a deletion control value to a job server 300ₛ₁ in the same installation area S₁ as the image processing apparatus 200ₛ₁.

As shown in FIG. 15, the image processing apparatus 200ₛ₁ transfers login information including user identification information to the job acquisition part 22 by way of the login part 21 (step S501).

Next, upon receiving a job list display instruction of the login user on the screen, the image processing apparatus 200ₛ₁ transmits user identification information of the login user and apparatus identification information of the image processing apparatus 200ₛ₁ to the Web server 100 by way of the job acquisition part 22, and requests to acquire the basic job list 22D₁ (step S502). Upon receiving a basic job list acquisition request from the image processing apparatus 200ₛ₁, the Web server 100 accesses the control information retention part 10 by way of the connection control part 11, refers to the retained control information 10D (step S503), and determines a job server 300ₛ₁ in the same installation area S₁ as the image processing apparatus 200ₛ₁ to be a connection destination that acquires the basic job list 22D₁ (step S504).

Next, the Web server 100 the user identification information received from the image processing apparatus 200ₛ₁ and a deletion control value in the same area (e.g., a setting value [30 (minutes)] of a deletion control corresponding to a determination result of the same installation area) to the determined job server 300ₛ₁ by way of the connection control part 11, and requests to acquire a job list of the login user (step S505).

Upon receiving the job list acquisition request from the Web server 100, the job server 300ₛ₁ accesses the job retention part 30 by way of the job list providing part 31, and acquires the job list 22D including information about an accumulated job of the login user (step S506).

At this time, the job list providing part 31 updates the corresponding management information 30D of the accumulated job of the login user (step S507). The job list providing part 31 updates the corresponding management information 30D based on the deletion control value received when being requested to acquire. The job list providing part 31 sets the deletion control value (received value) received when being requested to acquire into a deletion control value of the job attribution information of the management information 30D specified in acquiring the job list, and updates the deletion control value.

Next, the job server 300ₛ₁ transmits the job list 22D to the Web server 100 by way of the job list providing part 31, and responds to the job list acquisition request (step S508).

Upon receiving the job list response from the job server 300ₛ₁, the Web server 100 transfers the job list 22D received from the job server 300ₛ₁ to the job list creation part 12 by way of the connection control part 11, and requests to create a basic job list 22D₁ (step S509).

Next, the Web server 100 creates the basic job list 22D₁ by adding the server identification information of the job server 300ₛ₁ (connection destination) to the received job list 22D by way of the job list creation part 12 (step S510), transfers the created job list to the connection control part 11, and responds to the basic job list creation request (step S511).

Then, the Web server 100 transmits the received basic job list 22D₁ to the image processing apparatus 200ₛ₁ by way of the connection control part 11, and responds to the basic job list acquisition request (step S512).

Upon receiving the basic job list acquisition request from the Web server 100, the image processing apparatus 200ₛ₁ displays the received basic job list 22D₁ on the screen by way of the job acquisition part 22, and receives a job execution instruction from the login user by allowing a job to be selected on the screen (step S513).

Upon receiving a job execution instruction of the login user on the screen, the job acquisition part 22 transmits the job identification information of the selected job and the server identification information in which the selected job is accumulated to the Web server 100, and requests to acquire the execution job (step S514).

Upon receiving the execution acquisition request from the image processing apparatus 200ₛ₁, the Web server 100 transmits the job identification information received from the image processing apparatus 200ₛ₁ to the job server specified by the server identification information by way of the connection control part 11, and requests to acquire the execution job (step S515).

Upon receiving the execution job acquisition request from the Web server 100, the job server 300ₛ₁ accesses the job retention part 30 by way of the job providing part 32, and acquires the execution job of the login user (step S516).

Next, the job server 300ₛ₁ transmits the job data to the Web server 100 by way of the job proving part 32, and responds to the execution job acquisition request (step S517).

Upon receiving the execution job acquisition request from the job server 300ₛ₁, the Web server 100 transmits the job data received from the job server 300ₛ₁ to the image processing apparatus 200ₛ₁ by way of the connection control part 11, and responds to the execution job acquisition request (step S518).

Upon receiving the execution job acquisition response from the Web server 100, the image processing apparatus 200ₛ₁ transfers the job data received from the Web server 100 by way of the job acquisition part 22, and requests to execute the job (step S519).

As a result, the image processing apparatus 200ₛ₁ prints the received job data by way of the job execution part 23, and executes the job that the user desires to implement (step S520).

<<Job List Display Control Process>>

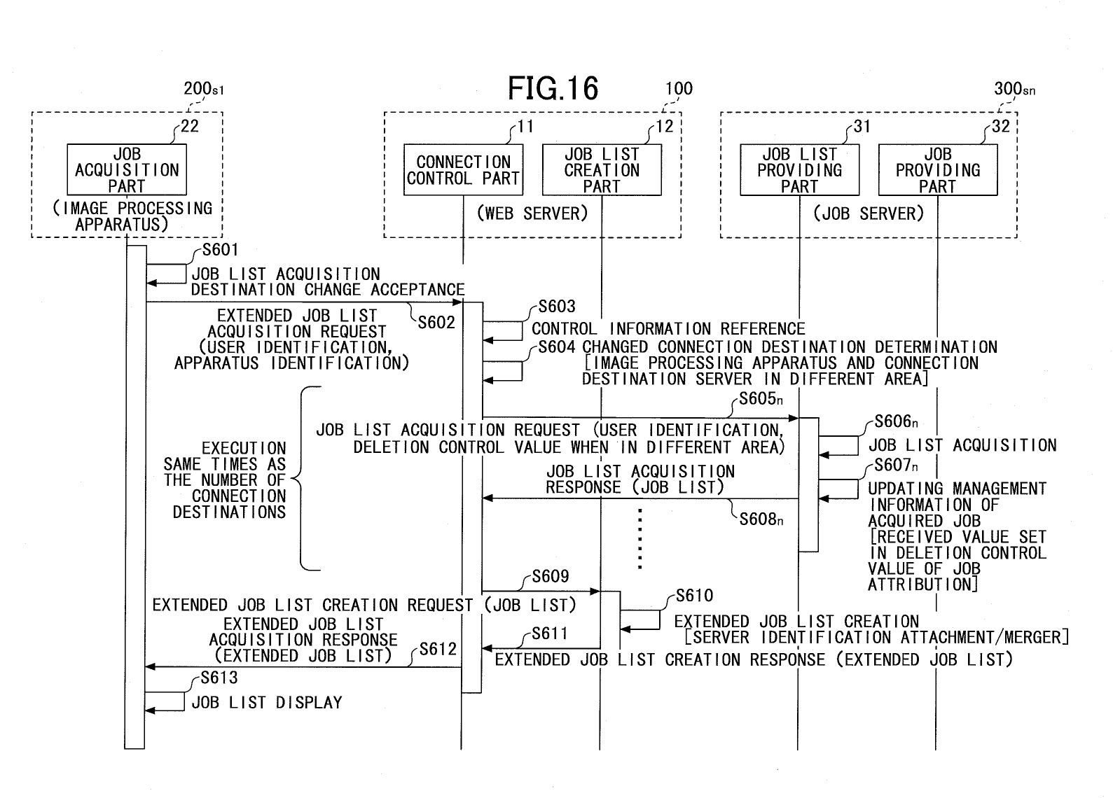

FIG. 16 is a sequence diagram showing a processing procedure example of an extended job list display of the present embodiment. FIG. 16 shows a processing procedure example where the image processing apparatus 200ₛ₁ does not have a job that the login user desires to implement in the displayed basic job list 22D₁, receives an instruction to change a job list acquisition destination, and displays an extended job list 22D₂. In other words, FIG. 16 shows a job list display process if the image processing apparatus 200ₛ₁ receives an instruction of changing a job list acquisition destination in the process of step S513 shown in FIG. 15. Among this, a process is shown where the Web server 100 transmits a job list acquisition request including a deletion control value to a job server 300ₛₙ in an installation area Sₙ different from the image processing apparatus 200ₛ₁.

As shown in FIG. 16, the image processing apparatus 200ₛ₁ receives a job list acquisition destination changing instruction from the login user by allowing the [Follow Me] tab to be pressed on the screen (step S601).

Upon receiving the job list acquisition destination changing instruction of the login user, the image processing apparatus 200ₛ₁ transmits user identification information of the login user and apparatus identification information of itself to the Web server 100, and requests to acquire an extended job list 22D₂ (step S602).

Upon receiving the extended job list acquisition request from the image processing apparatus 200ₛ₁, the Web server 100 accesses the control information retention part 10 by way of the connection control part 11, refers to the retained control information 10D (step S603), and determines the job server 300s that acquires the extended job list 22D₂ to be a changed connection destination (step S604).

In this way, in the Web server 100, if the connection control part 11 acquires plural server identification information, plural job servers 300ₛₙ to be changed connection destination are determined. In this case, the following process is performed between the Web server 100 and the respective job servers 300ₛₙ.

The Web server 100 transmits the user identification information received from the image processing apparatus 200ₛ₁ and a deletion control value in a case of a different area (e.g., a setting value [three (months)] of deletion control corresponding to a determination result in a different installation area) to the determined job server 300ₛₙ by way of the Web server 100, and requests to acquire a job list of the login user (step S605ₙ).

Upon receiving the job list acquisition request from the Web server 100, the respective job servers 300ₛₙ accesses the job retention part 30 by way of the job list providing part 31, and acquires job lists 22D including information about an accumulated job of the login user (step S606ₙ).

At this time, the job list providing part 31 updates corresponding management information 30D of the accumulated job of the login user (step S607ₙ). The job list providing part 31 updates the corresponding management information 30D based on the deletion control value received in requesting to acquire the job list. The job list providing part 31 sets the deletion control value (received value) received in requesting to acquire the job list into a deletion control value of job attribution information of the management information 30D specified in acquiring the job list, and updates the deletion control value.

Next, the respective job servers 300, transmits the job list 22D to the Web server 100 by way of the job list providing part 31, and responds to the job list acquisition request (step S608ₙ).

In other words, the above-stated process is performed the same number of times as the number of the determined connection destinations between the Web server 100 and the respective job servers 300ₛₙ.

Next, upon receiving the job list response from the respective job servers 300ₛₙ, the Web sever 100 transfers the plural job lists 22D received from the respective job servers 300ₛₙ to the job list creation part 12, and requests to create a extended job list 22D₂ (step S609).

Next, the Web server 100 adds the server identification information of the respective job servers 300ₛₙ (changed connection destination) to the received plural job lists 22D by way of the job list creation part 12, and creates the extended job list 22D₂ by merging the plural job lists to which the server identification information is added into one job list 22D₂ step S610). The job list creation part 12 transfers the created job list 22D₂ to the connection control part 11, and responds to the extended job list creation request (step S611).

Next, the Web server 100 transmits the received extended job list 22D₂ to the image processing apparatus 200ₛ₁ by way of the connection control part 11, and responds to the extended job list acquisition request (step S612).

Upon receiving the extended job list acquisition response from the Web server 100, the image processing apparatus 200ₛ₁ displays the received extended job list 22D₂ on the screen by way of the job acquisition part 22 (step S613).

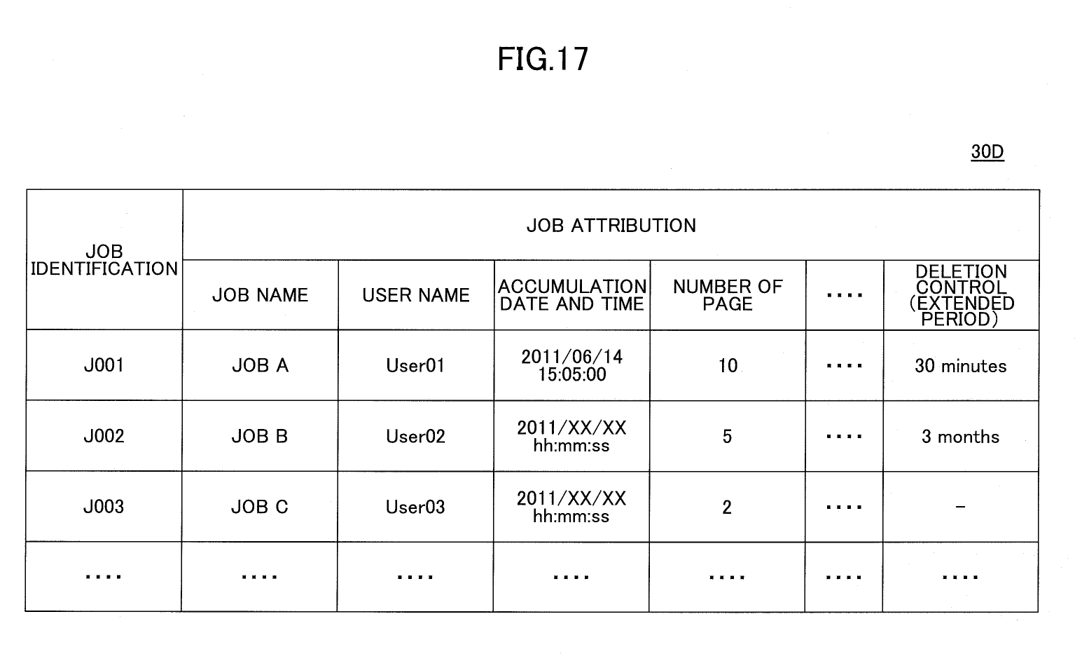

FIG. 17 is a diagram showing a data transition example (first example) of the management information 30D of the present embodiment. FIG. 17 shows a data transition example caused by an updating process of the management information 30D performed by the job list providing part 31. More specifically, FIG. 17 shows the data transition example of the process of the above-mentioned steps S507 and S607ₙ being performed.

As shown in FIG. 17, if user identification information of the login user (received user identification information) is [User01], and a connection destination to acquire the job list 22D is the job server 300ₛ₁ in the same installation area S₁ as the image processing apparatus 200ₛ₁, through the above-mentioned updating process (step S507), a deletion control value of job attribution information including the user identification information [User01] is updated in the received value in a case of the same area: [30 (minutes)].

Furthermore, if the user identification information of the login user is [User02], and the connection destination to acquire the job list 22D is a job server 300ₛₙ in an installation area different from the image processing apparatus 200ₛ₁, through the above-mentioned updating process (step S607ₙ), a deletion control value of the job attribution information including user identification information [User02] is updated in the received value in a case of a different area: [three (months)].

Thus, in a stage receiving the job list acquisition request, the value received from the Web sever 100 is set in a deletion control value of the job attribution information.

<<Main Process of Data Management>>

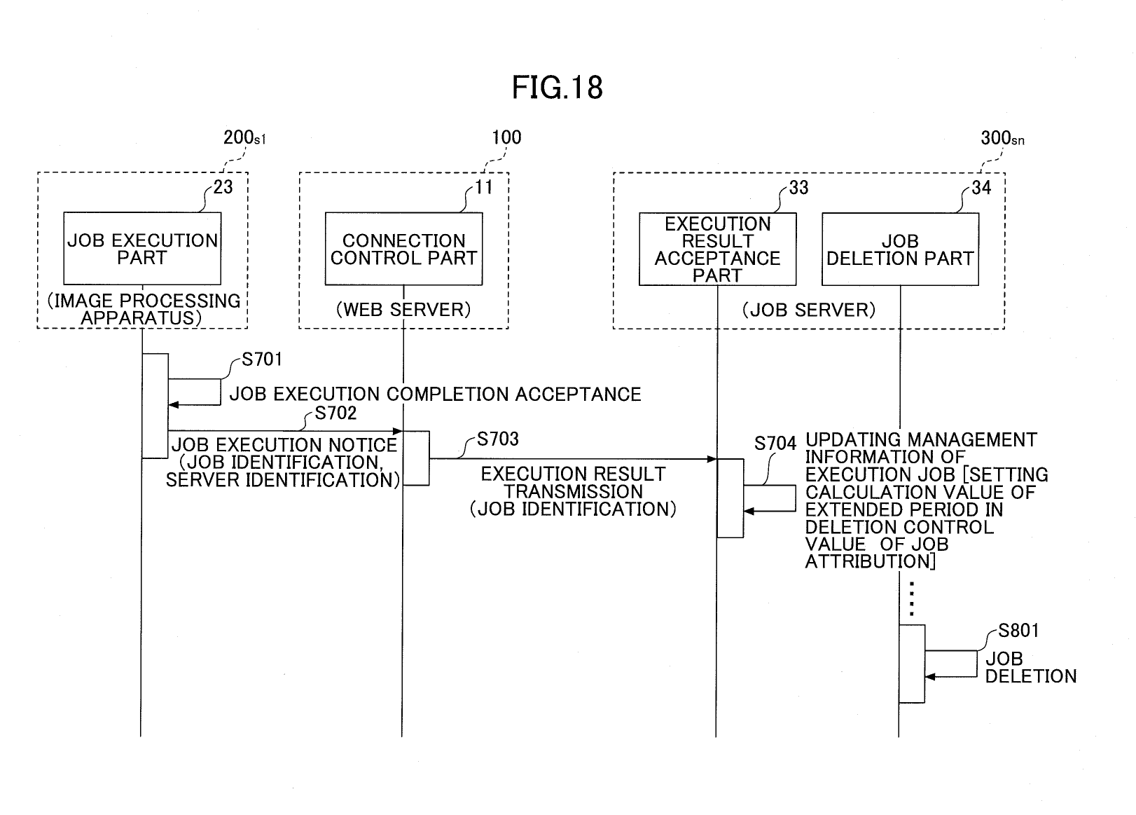

FIG. 18 is a sequence diagram showing a processing procedure example of the data management of the present embodiment. FIG. 18 shows a processing procedure example where the Web server 100 receives a job execution notice from the image processing apparatus 200ₛ₁, and transmits an execution result of a corresponding accumulated job to the job server 300ₛ₁ in which the execution job is accumulated, and job data is deleted in the job server 300ₛ₁. In other words, FIG. 18 shows a data management process if the image processing apparatus 200ₛ₁ performs the accumulated job in the process of step S520 shown in FIG. 15.

As shown in FIG. 18, the image processing apparatus 200ₛ₁ receives the execution completion of the accumulated job (step S701), transmits the job identification information of the execution job and the server identification information to identify an accumulation destination of the execution job to the Web server 100 by way of the job execution part 23, and notifies the job execution (step S702).

Upon receiving the job execution notice from the image processing apparatus 200ₛ₁, the Web server 100 transmits the received job identification information to the job server 300ₛ₁ (accumulation destination of the execution job) specified based on the received server identification information as an execution result (step S703).

Upon receiving the job identification information as the execution result from the Web server, the job server 300ₛ₁ accesses the job retention part 30 by way of the execution result acceptance part 33, and updates the corresponding management information 30D of the execution job (step S704).

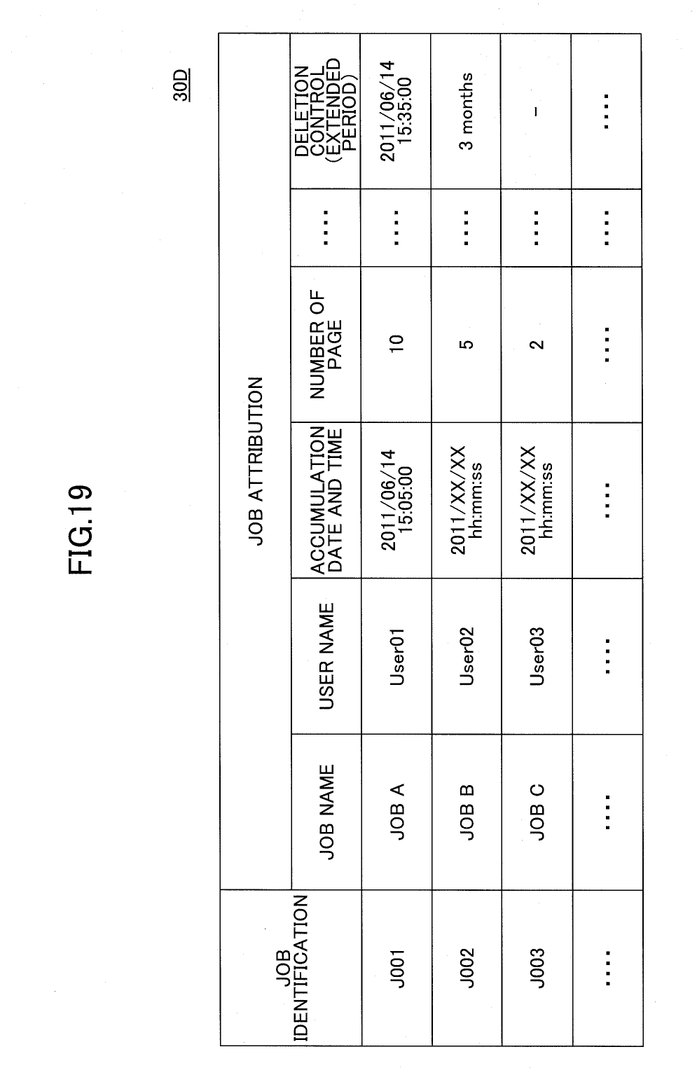

At this time, the execution result acceptance part 33 refers to the management information 30D based on the received job identification information, and specifies the job attribution information associated with the corresponding job identification information. For example, if the deletion control value set in receiving the job list acquisition request is [30 (minutes)], and the date and time set in receiving the execution result is [06/14/2011 15:05:00], the execution result acceptance part 33 adds the set deletion control value to the date and time in receiving the execution result, resets the calculated value (i.e., the calculated value of an extended period) [06/14/2011 15:35:00] in a deletion control value of the specified job attribution value, and updates the deletion control value. This causes the data transition of the management information 30D of the execution job, for example, as shown in FIG. 19.

FIG. 19 is a diagram showing a data transition example (second example) of the management data 30D of the present embodiment. FIG. 19 shows a data transition example of the job identification information (received job identification information) of the execution job being [J001] in the execution result acceptance part 33. As shown in FIG. 19, through the above-mentioned updating process (step S704), the deletion control value of the job attribution information associated with the job identification information [J001] is updated to an extended period: [06/14/2011 15:35:05].

In this manner, in a state of receiving the job execution notice, the extended period calculated based on the received value is set in the deletion control value of the job attribution information.

The description returns to FIG. 17. The job server 300ₛ₁ regularly performs the job deletion process asynchronously with the above-mentioned updating process by way of the job deletion part 34 (step S801).

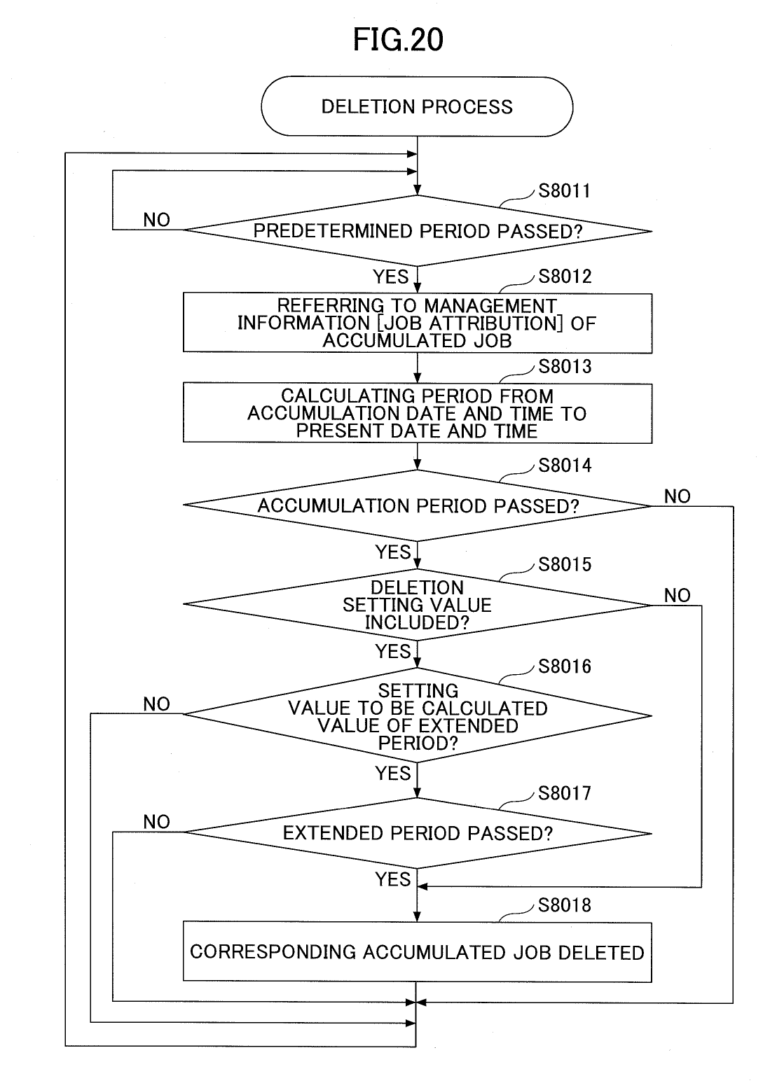

A detailed description is given about the above-stated job deletion process (step S801) with reference to FIG. 20. FIG. 20 is a flowchart showing a processing procedure of the job deletion of the present embodiment. As shown in FIG. 20, the job deletion part 34 determines a predetermined time passage preliminarily set as execution timing of the job deletion (step S8011).

When the predetermined time has passed (step S8011: YES), the job deletion part 34 performs the deletion process based on the following determination result of the deletion condition. However, while the predetermined time has not passed (step S8011: NO), the deletion process is not performed.

The job deletion part 34 accesses the job retention part 30, and refers to the job attribution information (step S8012).

The job deletion part 34 calculates a period from the accumulation date and time of the job attribution information to the present date and time when the deletion is determined (step S8013).

The job deletion part 34 determines whether the calculated period goes over the accumulation period of the accumulated job (step SS8014). At this time, the job deletion part 34 determines whether the calculated time runs over the preliminarily set accumulation period.

If the calculated time has passed the accumulation period (step S8014: YES), the job deletion part 34 determines whether a deletion control value is set in the job attribution information of the accumulated job that is determined to run over the accumulation period (step S8015).

If the deletion control value is set (step S8015: YES), the job deletion part 34 determines whether the setting value is the calculated value of the extended period (step S8016). More specifically, the job deletion part 34 determines whether the deletion control value is the setting value of the deletion control received in accepting the job list acquisition request, or the reset value of the deletion control calculated in accepting the job execution notice.

If the setting value of the deletion control is the calculated value of the extended period (step S8016: YES), the job deletion part 34 determines whether the set deletion control value goes over the extended period (step S8017). At this time, the job deletion part 34 determines whether the present date and time in determining the deletion runs over the extended period set in the deletion control value.

If the present date and time exceeds the extended period (step S8017: YES), the job deletion part 34 deletes the accumulated job that is determined to go over the extended period (step S8018). At this time, the job deletion part 34 deletes the job data of the accumulated job corresponding to the above-mentioned deletion condition and the management information 30D associated with the job data.

Here, if the present date and time runs over the extended period, and the deletion control value is not set (steps S8014: YES, S8015: NO), the job deletion part 34 executes the deletion process. In contrast, if the present date and time does not go over the accumulation period (step S8014: NO); the set deletion control value is not the calculated value of the extended period (step S8016: NO); or the present date and time does not exceed the extended period (step S8017: NO), the job deletion part 34 does not implement the deletion process.

<Summary>

As discussed above, in accordance with the Web server 100 of the present embodiment, if the connection control part 11 receives a job list acquisition request from the image processing apparatus 200s, a job server 300s to acquire a job list 22 (connection destination) is determined. The connection control part 11 transmits a job list acquisition request including a deletion control value (a value showing an extended period) of an accumulated job included in the job list 22D to the determined job server 300s. As a result, in the job server 300s, the job list providing part 31 returns the job list 22D of the accumulated job to the Web server 100, and updates management information 30D of corresponding accumulated jobs (deletion control value of job attribution information) based on the deletion control value included in the job list acquisition request. Subsequently, in the job server 300s, the job deletion part 34 performs job deletion based on the updated management information 30D, and timing of deleting the accumulated job is extended.

By doing this, the print control system 1 exerts an effect similar to the first embodiment.

In addition, the print control system 1 of the present embodiment provides an environment in which all the accumulated jobs of a user who has requested to acquire the job list 22D are not deleted during the extended accumulation period. As a result, the deletion control can be performed as a user unit, whereas the deletion control is performed as a job unit.

### Third Embodiment

The above-stated embodiments assume a job server that regularly implements a job deletion process in accordance with a preliminarily set accumulation period. However, some job servers may regularly perform the job deletion process depending on an execution state of an accumulated job. More specifically, in a regular process, the accumulated job having been processed is deleted.

Hence, the third embodiment assumes the above-mentioned job server, and suggests a structure in which the Web server moves job data of an unprocessed accumulated job between the job servers when obtaining a job list in a relay process between the image processing apparatus and the job server, by which timing of deleting the accumulated job can be extended because even if an accumulated job that is already processed (which is hereinafter called a “processed job” for convenience) is deleted in one job server, the same job that is not processed yet is accumulated in the other job server.

Hereinafter, a description is given only about matters different from the above-mentioned embodiments; the same numerals are put to the same matters; and the description is omitted.

<Data Management Function in Print Control>

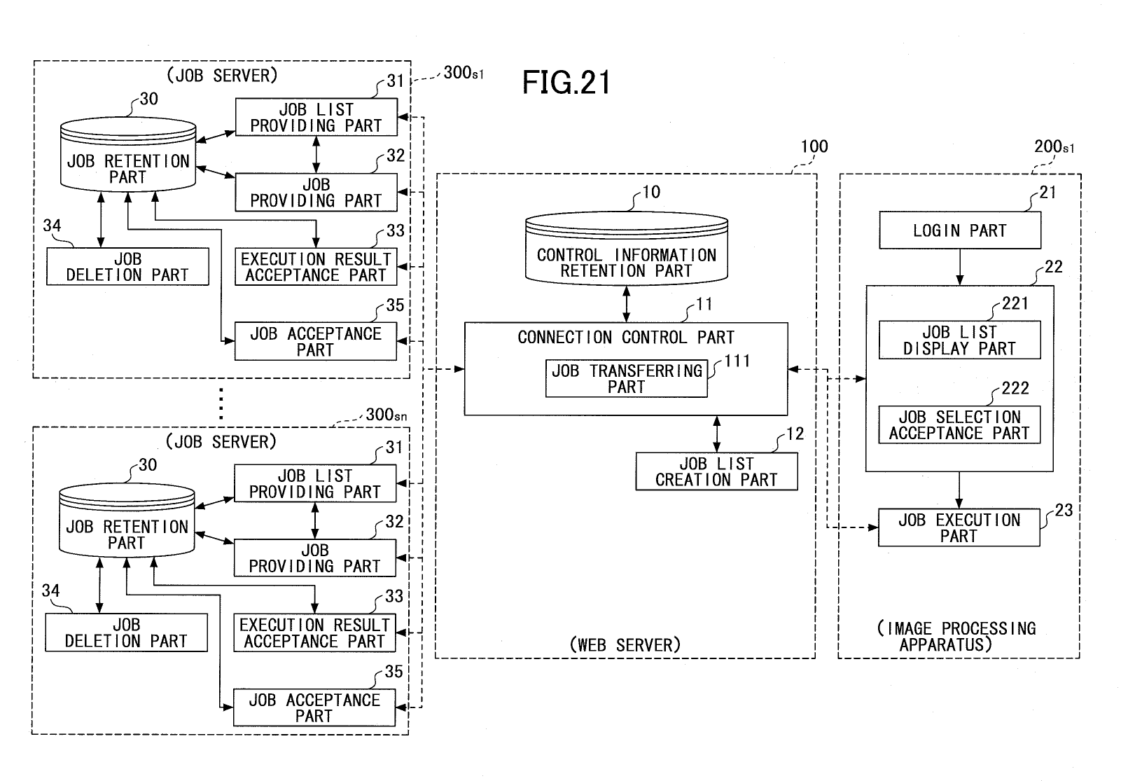

FIG. 21 is a diagram showing a functional example of print control and data management of the present embodiment.

<<Web Server>>

The Web server 100 performs a relay process such as a job list acquisition request, a job list response and the like between the image processing apparatus 200s that has performed a job list acquisition request of a user and the job server 300s determined to be a connection destination that acquires a job list 22D.

In the present embodiment, at this time, the connection control part 11 transmits the job list/job data acquisition request to the job server 300s.

The connection control part 11 determines whether the job server 300s to be the connection destination in acquiring the job list/job data and the image processing apparatus 200s of a requestor are in the same installation area S. The connection control part 11 controls whether to transmit the job list/job data acquisition request or a job list acquisition request based on the determination result.

In the present embodiment, when the Web server 100 receives the job list acquisition request from the image processing apparatus 200s, the following operation of job list acquisition request control is performed.

If the job server 300s in the same installation area S₁ is determined to be the connection destination, the connection control part 11 transmits the job list acquisition request to the job server 300ₛ₁. On the other hand, if a job server 300ₛₙ in an installation area Sₙ different from the image processing apparatus 200ₛ₁ is determined to be the contact destination, the connection control part 11 transmits the job list/job data acquisition request. As a result, the connection control part 11 transmits job data received from the job server 300ₛₙ to the job server 300ₛ₁ in the same installation area S₁ as the image processing apparatus 200ₛ₁, and moves the job data of the accumulated job included in the job list 22D.

Thus, in the present embodiment, if the installation area Sₙ of the destination job server 300ₛₙ is different from that of the image processing apparatus 200ₛ₁, the Web server acquires the job data of the unprocessed accumulated job from the job server 300s, and transfers the job data between the job servers 300s.

In the same installation area Sₙ, because the job server 300ₛ₁ is in the same installation area S₁ as the image processing apparatus 200ₛ₁ that has executed the accumulated job, even if the processed accumulated job is deleted in the job server 300ₛ₁, the environment is easy for a user to accumulate the job again. However, in the different installation area Sₙ, because the job server 300ₛₙ is in the installation area S₁ different from the image processing apparatus 200ₛ₁ that has executed the accumulated job, the environment is difficult for a user to accumulate the job again. Considering these points, in the present embodiment, even in a difficult situation for a user to perform re-accumulation, extension of timing of deleting the accumulated job is implemented by transferring the job data between the job servers 300s.

Moreover, upon receiving a job execution notice from the image processing apparatus 200s, the Web server 100 receives job identification information of the job execution and server identification information that identifies an accumulation destination of the execution job from the image processing apparatus 200s.

In response to this, the connection control part 11 transmits the received job identification information to the job server 300s to be the accumulation destination of the execution job as an execution result of the accumulated job. Here, the connection control part 11 specifies the job server 300s corresponding to the transmission destination of the execution result based on the server identification information that identifies the accumulation destination of the execution job. This allows the job server 300s to receive the execution result of the accumulated job it retains itself.

<<Job Server>>

Upon receiving the job list/job data acquisition request from the Web server 100, the job server 300s receives user identification information of a login user from the Web server 100.

In response to this, the job list providing part 31 returns the job list 22D and the job data of the accumulated job included in the job list 22D to the requestor. The job list providing part 31, after acquiring the job list 22D, transfers the job identification information included in the job list 22D, and requests to acquire the corresponding job data. As a result, the job providing part 32 returns the job data of the accumulated job included in the job list 22D to the job list providing part 31. This allows the job server 300s to return the job list 22D and the job data included in the job list 22D to the Web server to be a requestor by way of the job list providing part 31.

After that, the job data of the accumulated job included in the job list 22D are sent to the job server 300s in the same installation area S as the image processing apparatus 200s to be the job list/job data acquisition requestor. At this time, the job server 300s receives the job data by way of the job acceptance part 35, and accumulates the job data in the job retention part 30. Here, management information 30D in which an unprocessed value is set to be the execution state value associated with the accumulated job data is also newly registered.

Furthermore, upon receiving the execution result of the accumulated job from the Web server 100, the job server 300s receives the job identification information of the execution job.

In response to this, the execution result acceptance part 33 refers to the management information 33D retained in the job retention part 30 based on the received job identification information, and specifies job attribution information associated with the corresponding job identification information. The execution result acceptance part 33 updates the execution state value of the specified job attribution information (i.e., item value showing an execution state of the accumulated job).

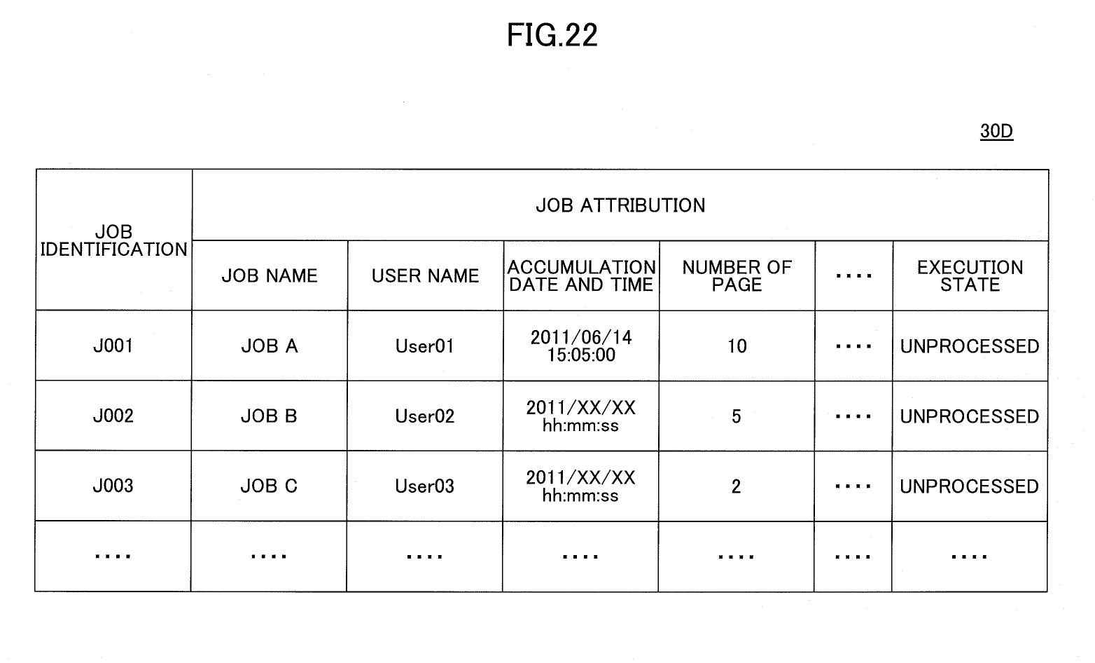

Here, a description is given about a data example of the management information 30D of the present embodiment. FIG. 22 is a diagram showing a data example of the management information 30D of the present embodiment. The management information 30D of the present embodiment differs from the management information 30D shown in the above-mentioned embodiments in that the job attribution information includes an item value that shows an execution state of the accumulated job (i.e., execution state value) instead of the item value that controls the deletion process of the accumulated job (i.e., deletion control value).

As the execution state value of the job attribution information, a value showing an unprocessed state is retained as a default value in accumulating a job, and the value is updated in a value showing a processed state in executing the job by a data management function described below.

The description returns to FIG. 21. The execution result acceptance part 33 updates the execution state value of the specified job attribution information in receiving the job execution notice in the value showing the processed state (i.e., updated from the default value in the latest value). For example, the execution result acceptance part 33 updates the execution state value of the job attribution information from [unprocessed] to [processed].

In response to this, the job deletion part 34 regularly refers to the management information 30D retained by the job retention part 30, executes the deletion process if the execution state value of the job attribution information is a value showing a processed state, and does not execute the deletion process if the execution state value is a value showing an unprocessed state.

Accordingly, in the present embodiment, the deletion process of the accumulated job corresponding to the execution job is performed in the job server 300.

In this way, in the print control system 1 of the present embodiment, even if a processed job is deleted in one job server 300ₛₙ, the same job is accumulated in another job server 300ₛ₁ as an unprocessed job, by which an environment of the processed job not being deleted is provided.

<<Job List Display Control Process>>

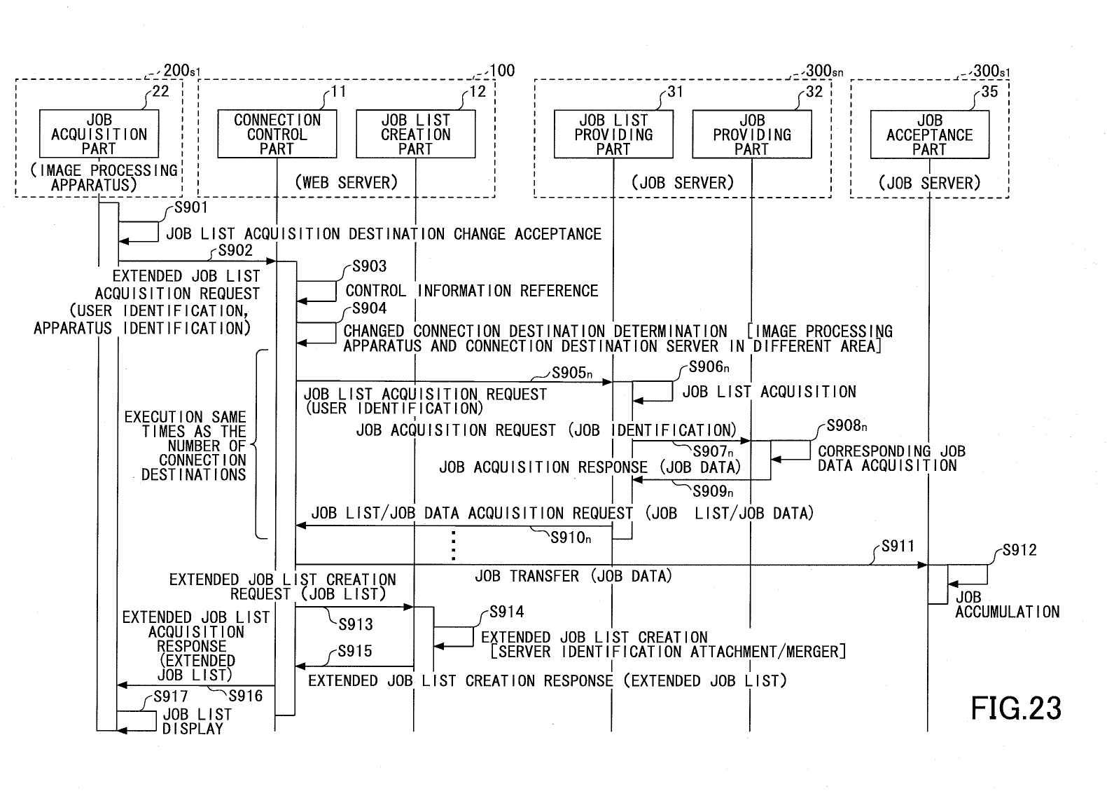

FIG. 23 is a sequence diagram showing a processing procedure example of an extended job list display of the present embodiment. FIG. 23 shows a processing procedure in which the image processing apparatus 200ₛ₁ does not include a job that a login user desires to implement in a displayed basic job list 22D, accepts an instruction to change a job list acquisition destination, and displays an extended job list 22D₂. In other words, FIG. 23 shows a job list displaying process in a case of the image processing apparatus 200ₛ₁ of accepting the instruction to change the job list destination in step S112 shown in FIG. 9. Among this, a process is shown where the Web server 100 transmits a job list/job data acquisition request to a job server 300ₛₙ in an area Sₙ different from the image processing apparatus 200ₛ₁.

As shown in FIG. 23, the image processing apparatus 200ₛ₁ accepts the job list acquisition destination changing instruction of the login user by allowing a [Follow Me] tab to be pressed on the screen (step S901).

Upon receiving the job list acquisition destination changing instruction of the login user, the image processing apparatus 200ₛ₁ transmits user identification information of the login user and apparatus identification information of itself to the Web server 100 by way of the job acquisition part 22, and requests to acquire an extended job list 22D₂ (step S902).

Upon receiving the extended job list acquisition request from the image processing apparatus 200ₛ₁, the Web server 100 accesses the control information retention part 10 by way of the connection control part 11, refers to the retained control information 10D (step S903), and determines a job server 300s that acquires the extended job list 22D₂ to be a changed connection destination (step S904).

In this manner, in the Web server 100, when the connection control part 11 receives plural server identification information, plural job severs 300ₛₙ to be the changed connection destination are determined. In this case, the following process is performed between the Web server 100 and the respective job servers 300ₛₙ.

The Web server 100 transmits the user identification information received from the image processing apparatus 200ₛ₁ to the determined job servers 300ₛₙ by way of the connection control part 11. Because the job servers 300ₛₙ are in installation areas Sₙ different from the image processing apparatus 200ₛ₁, the connection control part 11 in the Web server 100 requests to acquire the job list/job data of the login user (step S905ₙ).

Upon receiving the job list acquisition request from the Web server 100, the respective job server 300ₛₙ accesses the job retention part 30 by way of the job list providing part 31, and obtains the job list 22D including the information about the accumulated job of the login user (step S906ₙ).

At this time, the job list providing part 31 transfers the job identification information included in the obtained job list 22D to the job providing part 32, and requests to obtain the corresponding job data (step S907ₙ). As a result, the job providing part 32 accesses the job retention part 30, and acquires the corresponding job data (step S908ₙ). The job providing part 32 refers to the management information 30D of the accumulated job based on the received job identification information, and obtains the job data retained to be associated with the corresponding management information 30D. The job providing part 32 returns the obtained job data to the job list providing part 31 (step S909ₙ).

Next, the respective job servers 300ₛₙ transmit the job list 22D and the job data to the Web server 100 by way of the job list providing part 31, thereby respond to the job list/job data acquisition request (step S910ₙ). In other words, the above-mentioned process is performed the same number of times as the number of determined connection destination between the Web server and the respective job servers 300ₛₙ.

Next, upon receiving the job list/job data responses from the respective job servers 300_{Sn}, the Web server 100 transmits the plural job data received from the respective job servers 300ₛₙ to the job server 300ₛ₁ in the same installation area as the image processing apparatus 200ₛ₁ by way of the connection control part 11 (data transferring part), thereby transfers the job data of the accumulated job included in the job list 22D (step S911ₙ).

As a result, when the job server 300ₛ₁ receives the job data from the Web server, the job data received by way of the job acceptance part 35 are accumulated in the job retention part 30 (step S911ₙ). At this time, the job acceptance part 35 newly registers the management information 30D (execution state value: [unprocessed]) corresponding to the accumulated job.

Moreover, upon receiving the job list/job data response from the respective job servers 300ₛₙᵣ the Web server 100 transfers the plural job lists 22D received from the respective job servers 300ₛₙ by way of the connection control part 11, and requests to create an extended job list 22D₂ (step S913).

Next, the Web server 100 adds plural pieces of server identification information of the respective job servers 300ₛₙ (changed connection destination) by using the job list creation part 12, and creates an extended job list 22D₂ by merging the plural job lists 22D to each of which the server identification information has been added into one job list 22D₂ (step S914). The job list creation part 12 transfers the created job list 22D₂ to the connection control part 11, and responds to the extended job list creation request (step S915).

Then, the Web server 100 transmits the received extended job list 22D₂ to the image processing apparatus 200ₛ₁, and responds to the extended job list request (step S916).

Upon receiving the extended job list acquisition request from the Web server 100, the image processing apparatus 200ₛ₁ displays the received extended job list 22D₂ on the screen (step S917).

Here, the above-mentioned description describes a process where the job data received from the job server 300ₛₙ when acquiring the job list are transmitted to the job server 300ₛ₁, and the job data of the unprocessed accumulated job are transferred between the job servers, but the process is not limited to the job. To extend the timing of deleting the accumulated job, the job data of the processed job to be deleted only have to be accumulated in the job server 300s again. Accordingly, the following process is possible.

For example, it is possible to adopt a process where the job data acquired when obtaining the job list are sent to the job server 300s to be an acquisition destination, and the job data are accumulated as an unprocessed job again. Moreover, it is possible to adopt a process where the job data when acquiring the job list are sent to the job server 300s that has the longest accumulation period among the plural job servers 300s, and the job data are accumulated as an unprocessed job. Thus, it is only necessary to transmit the job data obtained when acquiring the job list to any of the plural job servers 300s and to accumulate the job data in the job server 300s again.

<<Main Process of Data Management>>

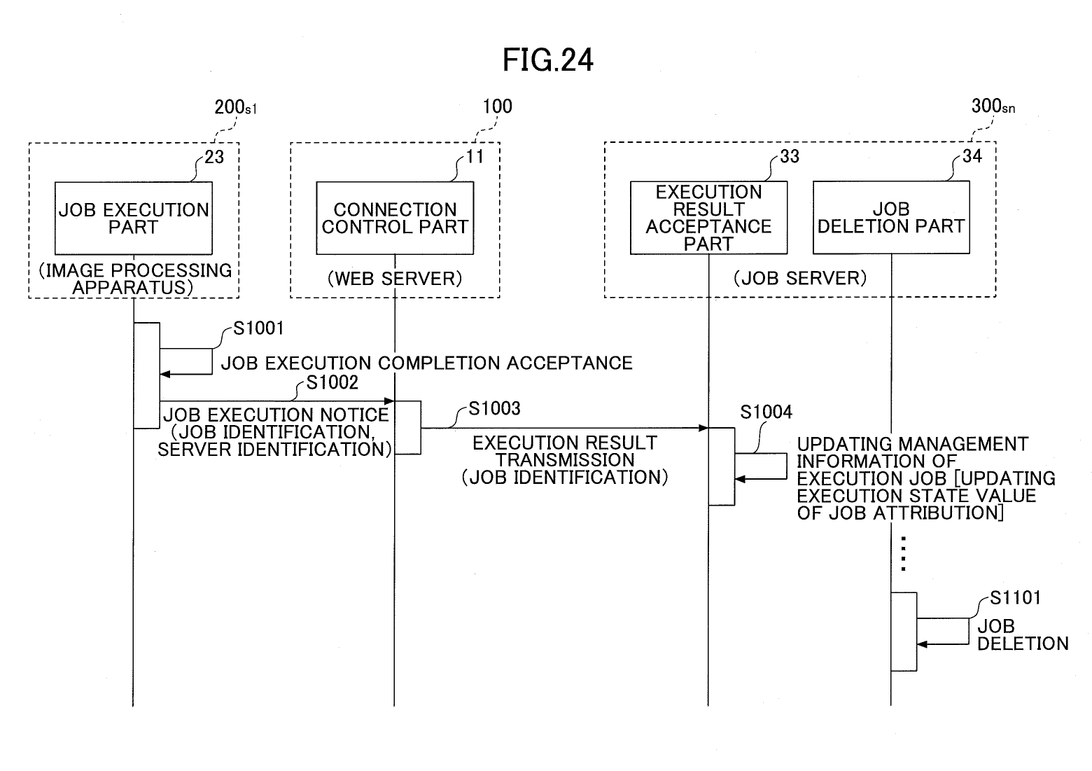

FIG. 24 is a sequence diagram showing a process procedure example of data management of the present embodiment. FIG. 24 shows a process procedure example where the Web server 100 accepts a job execution notice from the image processing apparatus 200ₛ₁, transmits an execution result notice to the job server 300ₛₙ in which an execution job is to be accumulated, and job data are deleted in the job server 300ₛₙ. In other words, FIG. 24 shows a data management process where the image processing apparatus 200ₛ₁ accepts an execution request of the accumulated job, and executes corresponding accumulated job in the process of step S917 shown in FIG. 23.

As shown in FIG. 24, upon receiving an execution completion of the accumulated job (step S1001), the image processing apparatus 200ₛ₁ transmits job identification information of the execution job, and server identification information to identify an accumulation destination of the execution job to the Web server 100 by way of the job execution part 23, and notifies job execution (step S1002).

Upon accepting the job execution notice from the image processing apparatus 200ₛ₁, the Web server 100 transmits the received job identification information to the job server 300, (i.e., accumulation destination of the execution job) specified based on the received server identified information as an execution result by way of the connection control part 11 (step S1003).

Upon receiving the job identification information as the execution result from the Web server 100, the job server 300ₛₙ accesses the job retention part 30 by way of the execution result acceptance part 33, and updates corresponding management information 30D of the execution job (step S1004).

At this time, the execution result acceptance part 33 refers to the management information 30D based on the received job identification information, and specifies job attribution information associated with the corresponding job identification information. The execution result acceptance part 33 updates a deletion control value of the specified job attribution information from the [unprocessed] to the [processed].

The job server 300ₛₙ regularly performs a job deletion process asynchronously with the above-mentioned updating process by way of the job deletion part 34 (step S1101).

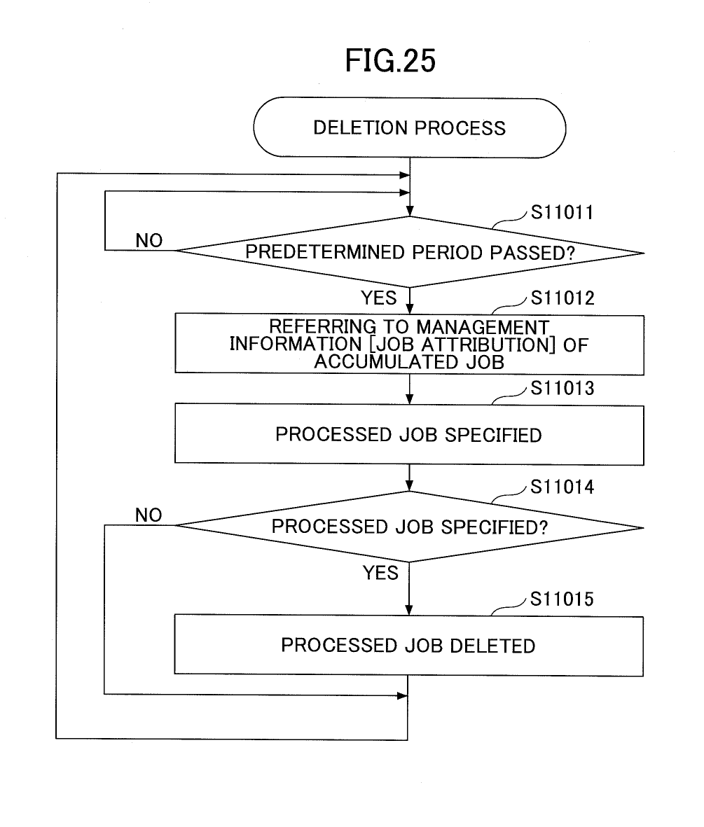

A detailed description is given about the above-stated job deletion process with reference to FIG. 25 (step S1101).

FIG. 25 is a flowchart showing a processing procedure example of a job deletion of the present embodiment. As shown in FIG. 25, the job deletion part 34 determines a predetermined time passage preliminarily set to be execution timing of the job deletion (step S11011).

When the predetermined time period has passed (step S11011: YES), the job deletion part 34 executes the deletion process based on a determination result of the following deletion condition. Here, while the predetermined time period has not passed (step S11011: NO), the deletion process is not implemented.

The job deletion part 34 accesses the job retention part 30, and refers to job attribution information of the management information 30D (step S11012).

The job deletion part 34 specifies a processed job from among accumulated jobs managed in the job retention part 30 based on an execution state value of the job attribution information (step S11013).

The job deletion part 34 determines whether the processed job is identified or not in the process of step S11013 (step S11014).

If the processed job is specified (step S11014: YES), the job deletion part 34 deletes the specified processed job (step S11015). At this time, the job deletion part 34 deletes the job data of the accumulated job corresponding to the above-mentioned deletion process and the management information 30D corresponding to the accumulated job.

Here, if the processed job is not specified (step S11014: NO), the job deletion control part 34 does not execute the deletion process.

<Summary>

As discussed above, according to the Web server 100 of the present embodiment, when the connection control part 11 accepts a job list acquisition request from the image processing apparatus 200ₛ₁, the connection control part 11 specifies the job server 300ₛₙ that acquires a job list.

The connection control part 11 determines whether the specified job server 300ₛₙ is a job server 300ₛ₁ in the same installation area S₁ as the image processing apparatus 200ₛ₁. If the specified job server 300ₛₙ and the image processing apparatus 200ₛ₁ are in a different installation area Sₙ, the connection control part 11 transmits a job list/job data acquisition request to the specified job server 300ₛₙ. As a result, the job server 300ₛₙ returns the job list and job data of an accumulated job to the Web server 100 by way of the job list providing part 31. When the Web server 100 accepts a response from the job server 300ₛₙ by way of the connection control part 11, the Web server 100 transmits the job data to the job server 300ₛ₁ in the same area as the image processing apparatus 200ₛ₁ by way of the data transferring part 111. As a result, the job data are accumulated in the job server 300ₛ₁. By doing this, even if the job deletion (the deletion of the processed job) is performed in the job server 300ₛₙ based on the execution result from the image processing apparatus 200ₛ₁, the same job (i.e., the unprocessed same job) is accumulated in the job server 300ₛ₁.

This allows the print control system 1 of the present embodiment to exert an effect similar to that of the first embodiment, and to extend the timing of deleting the accumulated job depending on an execution state of the accumulated job even in a system that performs the job deletion process regularly.

The description has been given about the above-mentioned embodiments so far, the “data management function” of the present embodiment is implemented by allowing arithmetic devices (CPUs) of the respective components that constitute the system 1 (such as the “Web server”, the “image processing apparatus”, the “job server” and the like) to execute a program obtained by encoding the respective processing procedure described with reference to drawings into a programming language suitable for an operating environment (i.e., platform).

The above-mentioned program, for example, in a case of the Web server 100 or the job server 300s, can be stored in a recording medium readable by a computer. With this, the above-stated program can be installed into the Web server 100 of the job server 300s through the drive device 103. In a case of the image processing apparatus 200s, the program can be stored in the recording medium 214a. This enables the above-mentioned program to be installed into the image processing apparatus 200s through the external memory I/F 214.

Moreover, because the Web server 100, the job server 300s, and the image processing apparatus 200s include the interface device 107 or the network I/F 213, the above-stated program can be downloaded and installed through an electric telecommunication line.

Furthermore, in the above-mentioned embodiments, the description has been given about a system structure in which the Web server 100 that performs a relay process between the image processing apparatus 200s and the job server 300s includes the print control and data management functions, but the system structure is not limited to this. For example, among the image processing apparatuses 200s or the job servers 300s in the system, at least one image processing apparatus 200s or job server 300s only has to have the print control and data management control functions.

In addition, in the present embodiment, the description has been given about the data management function that performs the deletion control of the accumulated job managed by the job server 300s, the data management function assumed in the present embodiment is not limited to this. The data management function of the present embodiment is applicable to a system in which a server that retains data (i.e., information processing apparatus) and an electronic device that performs a predetermined process by obtaining the data from the server are connected to each other as a control art of the data deletion. In other words, in the above-mentioned embodiments, the description has been given by taking the job server 300s as an example of the server that retains the data, and the image processing device 200s as an example of the electronic device that performs the predetermined process by obtaining the data from the server respectively.

As mentioned above, according to the embodiments of the present invention, it is possible to provide an information processing apparatus, a data management system and an information processing method that can implement data management to an accumulated job without the lack of convenience for a user.

As discussed above, the embodiments have described an information processing apparatus, a data management system and an information processing method, but the present invention is not limited to the specifically disclosed embodiments, and variations and modifications may be made without departing from the scope of the present invention.

The present application is based on Japanese Priority Patent Application No. 2011-149468, filed on Jul. 5, 2011, the entire contents of which are incorporated herein by reference.

What is claimed is:

1. An information processing apparatus connected to both plural data accumulation devices configured to accumulate job data in a predetermined memory area and plural electronic devices configured to execute the accumulated job data through a predetermined data transmission line, the data accumulation devices executing a deletion process based on a deletion control value included in management information to manage the accumulated job data and managing the accumulated job data within a capacity of the predetermined memory area, the apparatus comprising:
a control unit configured to control a communication process of the job data performed between the electronic devices and the data accumulation devices;
wherein the control unit is configured to transmit a control value for extending an accumulation period of the accumulated job data to at least one of the data accumulation devices in the communication process from at least one of the electronic devices to the at least one of the data accumulation devices, and to update the deletion control value of the management information retained in the predetermined memory area in the at least one of the data accumulation devices.

2. The information processing apparatus as claimed in claim 1,
wherein the control unit, upon accepting an execution notice of the accumulated job data from the at least one of the electronic devices, transmits an execution result including the control value for extending the accumulation period of the accumulated job data to be executed to the at least one of the data accumulation devices that manages the accumulated job data to be executed, and updates the deletion control value of the management information corresponding to the accumulated job data to be executed.

3. The information processing apparatus as claimed in claim 2,
wherein the control unit, upon accepting the execution notice of the accumulated data from the at least one of the electronic devices, determines whether the at least one of the electronic devices to execute the accumulated job data and the at least one of the data accumulation devices that manages the accumulated job data to be executed are in a same installation area, and transmits the execution result including the control value that is different depending on a determination result to the at least one of the data accumulation devices that manages the accumulated job data to be executed.

4. The image forming apparatus as claimed in claim 3, further comprising:
an information retention unit configured to retain device information and data accumulation device information in a predetermined secondary memory area, the device information including area identification information identifying an installation area and device identification information identifying the at least one of the electronic devices installed in the installation area that are associated with each other, the data accumulation device information including the area identification information and data accumulation device identification information identifying the installed data accumulation device that are associated with each other,
wherein the control unit is configured to access the information retention unit in accepting the execution notice from the at least one of the electronic devices,
to refer to the device information based on the device identification information received from the at least one of the electronic devices, to acquire the area identification information associated with the device identification information,
to refer to the data accumulation device information based on the data accumulation device identification information received from the at least one of the electronic devices, to acquire the area identification information associated with the data accumulation device identification information, and
to determine whether the at least one of the electronic devices to execute the accumulated job data and the at least one of the data accumulation devices that manages the accumulated job data to be executed are in the same area.

5. The information processing apparatus as claimed in claim 4,
wherein the control unit, in determining that the at least one of the electronic devices to execute the accumulated job data and the at least one of the data accumulation device that manages the accumulated job data to be executed are in a different installation area, transmits the execution result including the control value whose extended value of the accumulated period is set longer than that in determining that the at least one of the electronic devices to execute the accumulated job data and the at least one of the data accumulation device that manages the accumulated job data to be executed are in the same area to the at least one of the data accumulation devices that manages the accumulated job data to be executed.

6. The information processing apparatus as claimed in claim 1,
wherein the control unit, upon accepting a display information acquisition request of an accumulated job data catalog of a user, transmits the display information acquisition request including the control value for extending the accumulation period of the accumulated job data of the user to the at least one of the data accumulation device that manages the accumulated job data of the user, and updates the deletion control value of the management information corresponding to the accumulated job data of the user.

7. The information processing apparatus as claimed in claim 1,
wherein the control unit, upon accepting the display information acquisition request of the accumulated job data catalog of the user from the at least one of the electronic devices, determines one of the at least one of the data accumulation devices in the same installation area as the at least one of the electronic devices and the at least one of the data accumulation devices in the area different from the at least one of the electronic devices is a connection destination for acquiring display information of the accumulated job data catalog of the user, and transmits the display information acquisition request including the control value that is different depending on the connection destination to the determined at least one of data accumulation devices.

8. The information processing apparatus as claimed in claim 7, further comprising:
an information retention unit configured to retain device information and data accumulation device information in a predetermined secondary memory area, the device information including area identification information identifying an installation area and device identification information identifying the at least one of the electronic devices installed in the installation area that are associated with each other, the data accumulation device information including the area identification information and data accumulation device identification information identifying the installed data accumulation device that are associated with each other,
wherein the control unit is configured to access the information retention unit in accepting an execution notice from the at least one of the electronic devices,
to refer to the device information based on the device identification information received from the at least one of the electronic devices, to acquire the area identification information associated with the device identification information,
to refer to the data accumulation device information based on the acquired area identification information, to acquire data accumulation device identification information associated with the area identification information, to determine the at least one of the data accumulation devices in the same installation area as the at least one of the electronic device to be the connection destination for acquiring the display information of the accumulated job data catalog of the user, or
to refer to the data accumulation device information based on the acquired area identification information, to acquire the data accumulation device identification information not associated with the area identification information, to determine the at least one of the data accumulation devices in the installation area different from the at least one of the electronic device to be the connection destination for acquiring the display information of the accumulated job data catalog of the user, and
to transmit the display information acquisition request including user identification information identifying the user and the control value for extending the accumulation period of the accumulated job data of the user.

9. The information processing apparatus claimed in claim 8,
wherein the control unit, in determining the at least one of the data accumulation device in the installation area different from the at least one of the electronic devices to be the connection destination, transmits the display information acquisition request including the control value whose accumulation period is set longer than that in determining the at least one of the data accumulation device in the same installation area as at least one of the electronic devices to be the connection destination to the determined at least one of the data accumulation devices.

10. An information processing apparatus connected to both plural data accumulation devices configured to accumulate job data in a predetermined memory area and plural electronic devices configured to execute the accumulated job data through a predetermined data transmission line, the data accumulation devices performing a deletion process based on a deletion control value included in management information to manage the accumulated job data, and managing the accumulated job data within a capacity of the predetermined memory area, the apparatus comprising:
a control unit configured to control a communication process of the job data performed between the electronic devices and the data accumulation devices;
wherein the control unit is configured to acquire the accumulated job data from at least one of the data accumulation devices in an installation area different from at least one of the electronic devices in the communication process from the at least one of the electronic devices to the at least one of the data accumulation devices, and to transmit the acquired accumulated job data to any of the plural data accumulation devices.

11. The information processing apparatus as claimed in claim 10,
wherein the control unit, upon accepting a display information acquisition request of an accumulated job data catalog of a user, transmits the display information acquisition request and a data acquisition request of the accumulated job data of the user to a first data accumulation device in a first installation area different from the at least one of the electronic devices, and the accumulated job data acquired from the first data accumulation device in the first installation area to a second data accumulation device in a same installation area as the at least one of the electronic devices.

12. The information processing apparatus as claimed in claim 11, further comprising:
a information retention unit configured to retain device information and data accumulation device information in a predetermined secondary memory area, the device information including area identification information identifying an installation area and device identification information identifying the at least one of the electronic devices installed in the installation area that are associated with each other, the data accumulation device information including the area identification information and data accumulation device identification information identifying the installed data accumulation device that are associated with each other,
wherein the control unit is configured to access the information retention unit in accepting the display information acquisition request from the at least one of the electronic devices,
to refer to the device information based on the device identification information received from the at least one of the electronic devices, to acquire the area identification information associated with the device identification information,
to refer to the data accumulation device information based on the acquired area identification information, to acquire the data accumulation device identification information not associated with the area identification information, to determine the first data accumulation device in the first installation area different from the at least one of the electronic devices to be the connection destination for acquiring the display information of the accumulated job data catalog of the user,
to transmit the display information acquisition request including user identification information identifying the user and the data acquisition request to the determined first data accumulation device,
to refer to the device information based on the device identification information received from the at least one of the electronic devices, to acquire the area identification information associated with the device identification information in acquiring the accumulated job data from the first data accumulation device determined to be the connection destination for acquiring the catalog of the accumulated data of the user,
to refer to the data accumulation device information based on the acquired area identification information, to acquire the data accumulation device identification information associated with the second area identification information, to determine the second data accumulation device in the same installation area as the at least one of the electronic devices to be the connection destination for acquiring the display information of the accumulated job data catalog of the user, and
to transmit the acquired accumulated job data to the determined second data accumulation device.

13. A data management system comprising:
plural data accumulation devices configured to accumulate data in a predetermined memory area, to execute a deletion process based on a deletion control value included in management information for managing the accumulated data, and to manage the accumulated job data within a capacity of the predetermined memory area;
plural electronic devices configured to execute the accumulated job data and connected to the plural data accumulation devices through a predetermined data transmission line; and
an information processing apparatus connected to both the plural data accumulation devices and the plural electronic devices through predetermined data transmission lines,
wherein the information processing apparatus includes a control unit configured to control a communication process of the data performed between the electronic devices and the data accumulation devices;
wherein the control unit is configured to transmit a control value for extending an accumulation period of the accumulated job data to at least one of the data accumulation devices in the communication process from at least one of the electronic devices to the at least one of the data accumulation devices, and to update the deletion control value of the management information retained in the predetermined memory area in the at least one of the data accumulation devices.
